(19) United States
(12) Patent Application Publication
(10) Pub. No.: US 2008/0257188 A1
(43) Pub. Date: Oct. 23, 2008

(54) INK COMPOSITION, INKJET RECORDING METHOD, PRINTED MATERIAL, PRODUCTION METHOD OF A PLANOGRAPHIC PRINTNG PLATE AND PLANOGRAPHIC PRINTING PLATE

(75) Inventor: Kazuhiro YOKOI, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/857,784

(22) Filed: Sep. 19, 2007

(30) Foreign Application Priority Data
Sep. 28, 2006 (JP) 2006-265088

(51) Int. Cl. B41N 1/00; C08K 5/1545; C08F 2/46

(52) U.S. Cl. 101/453; 524/107; 524/110; 427/487

(57) ABSTRACT

The invention provides an ink composition comprising: a condensed cyclic lactone compound; a compound that generates an acid when irradiated with a radiation ray; a cationically polymerizable compound; and a colorant. Further, the invention provides an inkjet recording method using this ink composition, a printed material obtained by using the ink composition, and a planographic printing plate, and a method of producing a planographic printing plate.

### CROSS-REFERENCE TO RELATED APPLICATION

This application claims priority under 35 USC 119 from Japanese Patent Application No. 2006-265088, the disclosure of which is incorporated by reference herein.

### BACKGROUND OF THE INVENTION

1. Field of the Invention

The present invention relates to an ink composition favorably used for inkjet recording; an inkjet recording method; and a printed material using the same. Further, the present invention relates to a planographic printing plate obtained by using the ink composition and a method of producing the planographic printing plate.

2. Description of the Related Art

Image recording methods for forming an image based on image data signals on a recording medium such as paper include methods such as an electrophotographic method, a sublimation or fusion heat-transfer method, and an inkjet method. Among these, the inkjet method can be carried out using an inexpensive device, wherein the image is directly formed by ejecting ink only onto a desired image region on the recording medium, thus enabling an efficient use of ink and resulting in low running costs. In addition, the inkjet method generates little noise and is superior as an image recording method.

The inkjet method can be applied for printing not only on plain paper but also on a non-water absorptive recording medium such as a plastic sheet or a metal plate. However, higher speed and higher image quality at the time of printing are important issues, and the time period needed for drying and hardening ink droplets after ejection has a great influence on the printing efficiency and the quality of a printed image.

One of such inkjet recording methods is a method using an inkjet recording ink which is curable by irradiation with a radiation ray. In this method, printing efficiency can be improved and a sharp image can be obtained, by curing droplets by irradiating with a radiation ray immediately, or a given period of time, after the ejection.

By achieving higher sensitivity of inkjet recording ink which is curable by irradiation with a radiation ray such as an ultraviolet ray, the ink can be imparted with higher hardening properties, and thus many benefits can be obtained, such as improved inkjet recording efficiency, reduced power consumption, longer lifetime due to a reduced load on a radiation ray generator, and prevention of evaporation of low-molecular substances due to insufficient hardening. In addition, improvement in sensitivity is effective in increasing the strength of the image formed with the inkjet recording ink and, in particular, in the case of preparation of planographic printing plates, it may increase the hardness of the image region and printing durability.

Such inkjet methods using an ink composition which is curable by a radiation ray such as ultraviolet light have attracted attention recently for being relatively odorless, quick in drying, and capable of recording on a recording medium having reduced ink absorbency. Ultraviolet light curable ink compositions for inkjet recording utilizing radical polymerization have been disclosed (see, for example, Japanese Patent Application Laid-Open (JP-A) Nos. 63-235382, 3-216379, and 5-214280, and Japanese Patent Publication (JP-B) Nos. 6-21256 and 6-62905). In addition, compositions containing polymerizable compounds of specific radically polymerizable acrylates and a colorant have been proposed (see, for example, JP-A Nos. 2003-192943 and 2003-192944), for the purpose of providing an inkjet recording ink that can record an image having higher sensitivity and adhesiveness without ink bleeding, even on a recording medium on which it is normally difficult to record directly using the inkjet recording method, the ink being yet higher in stability with less skin irritation or sensitization. While such radically polymerizable inks are superior in hardening speed and can form an image without ink bleeding, they have had a disadvantage in that the adhesiveness to a recording medium deteriorates due to volume shrinkage during hardening.

For this reason, suggested is a cationically polymerizable ink composition which exhibits a smaller shrinkage ratio when cured by ultraviolet rays than radically polymerizable inks in order to improve the adhesiveness to a recording medium, the storage stability at high temperature, and others (see, for example, JP-A Nos. 9-183928, and 2004-10625). However, in order to make the adhesiveness to a recording medium better, it is desired about any cationically polymerizable ink also to restrain a shrinkage in the volume when the ink is cured.

### SUMMARY OF THE INVENTION

A first aspect of the present invention provides an ink composition comprising: a condensed cyclic lactone compound; a compound that generates an acid when irradiated with a radiation ray; a cationically polymerizable compound; and a colorant.

A second aspect of the invention provides an inkjet recording method comprising ejecting the above-mentioned ink composition onto a recording medium through an inkjet printer, and irradiating the jetted ink composition with a radiation ray, thereby curing the composition.

A third aspect of the invention provides a printed material obtained by ejecting the above-mentioned ink composition onto a recording medium through an inkjet printer, and then irradiating the ink composition with a radiation ray, thereby curing the composition.

A fourth aspect of the invention provides a method of producing a planographic printing plate comprising ejecting the above-mentioned ink composition onto a hydrophilic substrate, and irradiating the ink composition with a radiation ray to cure the composition, thereby forming a hydrophobic region.

A fifth aspect of the invention provides a planographic printing plate having a hydrophobic region formed by ejecting the above-mentioned ink composition onto a hydrophilic substrate, and then irradiating the ink composition with a radiation ray, thereby curing the composition.

### DETAILED DESCRIPTION OF THE INVENTION

[Ink Composition]

The ink composition of the present invention comprises (a) a condensed cyclic lactone compound, (b) a compound that generates an acid when irradiated with a radiation ray, (c) a cationically polymerizable compound, and (d) a colorant.

The term “radiation ray” in the present invention indicates any active radiation ray without any limitation, as long as it generates polymerization initiating radical in the ink composition, upon irradiation, and examples thereof include α-ray, γ-ray, X-ray, ultraviolet light, visible light, electron beam, and the like. Among them, ultraviolet light and electron beam are preferable, wherein ultraviolet light is particularly preferable, from the viewpoint of curing sensitivity and availability of equipment. Thus, the ink composition according to the present invention is preferably an ink composition which is curable by irradiation with an ultraviolet light as a radiation ray.

Cationically polymerizable ink compositions curable with a radiation ray such as ultraviolet light are advantageous in that the compositions exhibit a smaller shrinkage ratio in volume when irradiated with the radiation ray so as to be cured than radically polymerizable ink compositions. However, the volume shrinkage itself, which follows the polymerization, is not essentially avoided with ease. Thus, it has been desired to make the volume shrinkage ratio lower in order to improve the adhesiveness to a recording medium.

The ink composition of the invention contains a condensed cyclic lactone compound, thereby making it possible to make the volume shrinkage thereof lower when the composition is cured than conventional cationically polymerizable ink compositions. This advantageous effect appears to be expressed by a matter that the condensed cyclic lactone compound, which has a cyclic structure large in steric bulkiness, is contained in the ink composition.

By use of the condensed cyclic lactone compound, the composition can be cured with a high sensitivity. The strength of the film obtained by the curing can also be improved. This would be because at the time of irradiating the composition with the radiation ray, the lactone ring is ring-opened to undergo reaction.

The individual constituents used in the ink composition of the invention will be successively described hereinafter.

(a) Condensed Cyclic Lactone Compound]

The condensed cyclic lactone compound used in the invention is a condensed polycyclic hydrocarbon containing a lactone ring and a condensed ring which is condensed with this lactone ring.

In the invention, the “lactone ring”, which constitutes the condensed cyclic lactone compound, means only a moiety where the cyclic structure containing an ester bond moiety which constitutes the lactone ring is made of a single ring. For example, when two cyclic structures each containing an ester bond moiety are present in a single molecule, one of the rings is a 6-membered ring, the other is a 10-membered ring, and further two atoms out of the atoms constituting the 6-membered ring are owned by not only the 6-membered ring but also the ring constituting the 10-membered ring (for example, an exemplified compound A-1, which will be illustrated later), the 6-membered ring moiety, which has a monocyclic structure, is the “the lactone ring which constitutes the condensed cyclic lactone compound” referred to in the invention (in other words, the 10-membered ring moiety in the bicyclic structure is not the “the lactone ring which constitutes the condensed cyclic lactone compound” referred to in the invention).

The condensed ring which is condensed with the lactone ring means a ring which owns, together with the lactone ring, only the two carbon atoms which are adjacent to each other and are constituents of the ring structure of the lactone ring. Among, for example, compounds each having a lactone ring having a 6-membered ring structure and a condensed ring condensed with this lactone ring, condensed ring type lactone compounds wherein their condensed ring owns, together with the lactone ring, the carbon atoms at the α- and δ-positions in the lactone ring or the carbon atoms at the α- and γ-positions in the lactone ring are excluded from the category of the “condensed cyclic lactone compound” referred to in the invention. However, condensed ring type lactone compounds wherein their condensed ring owns, together with the lactone ring, the carbon atoms at the α- and β-positions, the carbon atoms at the β- and γ-positions, or the carbon atoms at the γ- and δ-positions in the lactone ring (for example, compounds represented by formulae (I-a) to (I-c) described later are included in the category of the “condensed cyclic lactone compound” referred to in the invention).

The condensed cyclic lactone compound used in the invention has a condensed structure wherein two rings jointly own two carbon atoms adjacent to each other, whereby the two rings are bonded to each other, as described above. For this reason, the lactone compound also has an advantage that the rigidity of the molecule thereof is higher so as to give a better film strength than lactone compounds having a spiro structure wherein two rings jointly own a single carbon atom, whereby the two rings are bonded to each other.

The number of the condensed rings which are condensed with the lactone ring is preferably from 1 to 4, more preferably from 1 to 2, and even more preferably 1 from the viewpoint of the solubility of the compound. The lactone ring is selected preferably from 4- to 10-membered rings, more preferably from 4- to 8-membered ring, and still more preferably from 4- to 6-membered rings from the viewpoint of the cationic polymerization reactivity.

When a single condensed ring is condensed to the lactone ring and further the lactone ring is a 4-membered ring (β-lactone ring), 5-membered ring (γ-lactone ring) or a 6-membered ring (δ-lactone ring), the condensed cyclic lactone compound used in the invention is preferably a compound having at least one selected from structures represented by the formulae (I-a) to (I-f):

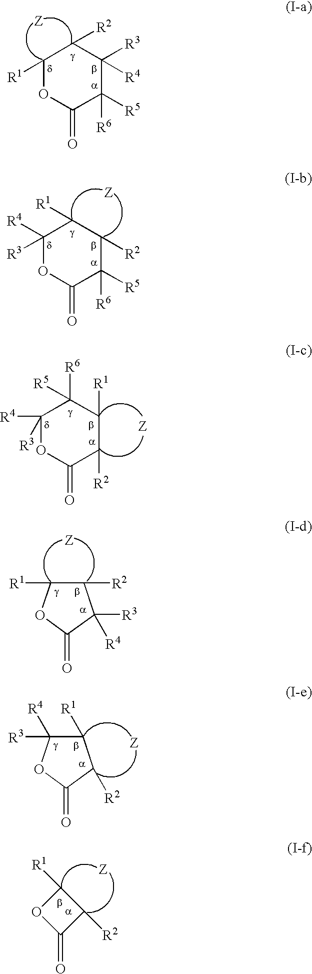

The condensed cyclic lactone compounds represented by the formulae (I-a) to (I-c) are compounds containing a δ-lactone ring and a single condensed ring condensed with this ring; the condensed cyclic lactone compounds represented by the formulae (I-d) to (I-e) are compounds containing a γ-lactone ring and a single condensed ring condensed with this ring; and the condensed cyclic lactone compound represented by the formula (I-e) is a compound containing a β-lactone ring and a single condensed ring condensed with this ring.

Among these three type condensed cyclic lactone compounds, particularly preferred are compounds containing a δ-lactone ring and a single condensed ring condensed with this ring in the invention from the viewpoint of the cationic polymerization reactivity.

In the formulae (I-a) to (I-f), Z represents a group which is combined with two carbon atoms which are constituents of a lactone ring, are adjacent to each other in the lactone ring and are bonded to Z, to form at least one condensed ring selected from the group consisting of 5-membered and 6-membered rings.

This condensed ring composed of Z and the two carbon atoms in the lactone ring moiety may have one or more unsaturated bonds. When the condensed ring is a 6-membered ring, the ring may have a benzene ring structure. The condensed ring may be a heteroring, which contains a heteroatom such as a nitrogen, oxygen or sulfur atom. When the heteroatom is a nitrogen atom in this case, the ring may have, for example, a pyrrole ring structure. When the heteroatom is an oxygen atom, the ring may have, for example, a furan ring structure. The heteroring may contain therein two or more heteroatoms or two or more different heteroatoms.

The condensed ring preferably has an aromatic ring structure, and more preferably has a benzene ring structure from the viewpoint of the storage stability of the compound and the cationic polymerization reactivity thereof.

A substituent may be bonded to each of the atoms which constitute the condensed ring (i.e., the atoms contained in the group represented by Z, from the atoms the two carbon atoms present also in the lactone ring moiety being excluded).

This substituent may be a hydrocarbon group having 1 to 20 carbon atoms. The substituent is, for example, an alkyl group such as a methyl group; an alkyloxy group such as a methoxy group; an aromatic group such as a phenyl group; or a group which contains an alkylene group (e.g., a methylene group) one end of which is bonded to one out of the atoms which constitute the condensed ring, and an aromatic group (e.g., a phenyl group) bonded to the other end of this alkylene group.

Among these substituents, preferred are the above-mentioned aromatic groups and groups which each contain an aromatic group bonded indirectly to the condensed ring through an alkylene group from the viewpoint of the cationic polymerization reactivity.

When at least two of the atoms which constitute the condensed ring condensed with the lactone ring (provided that these atoms are atoms contained in the group represented by Z, which are atoms other than the two carbon atoms in the lactone ring moiety) each have a substituent, the substituents may be bonded to each other to form at least one condensed ring structure selected from 5-membered and 6-membered rings. The condensed ring may contain one or more heteroatoms (such as oxygen) and/or one or more different heteroatoms.

R¹ and R² in general formulae (I-a) to (I-f) each represent a hydrogen atom when (A) one of the carbon atoms which are constituents of the lactone ring and an atom which is directly bonded to this carbon atom and are constituents of Z, form a single bond, and R¹ and R² therein are not present when (B) one of the carbon atoms which are constituents of the lactone ring and an atom which is directly bonded to this carbon atom and are constituents of Z form a double bond.

R³ and R⁴ in formulae (I-a) to (I-e) each represent a hydrogen atom or a hydrocarbon group having 1 to 20 carbon atoms when (C) R³ and R⁴ are not bonded to each other (provided that when one of the carbon atoms which are constituents of the lactone ring and an atom of R³ (or R⁴) which is directly bonded to this carbon atom form a double bond, R⁴ (or R³) is not present). The hydrocarbon group more preferably has 1 to 8 carbon atoms.

The hydrocarbon group selected as R³ or R⁴ is, for example, a saturated or unsaturated chain-form hydrocarbon group, such as an alkyl group (such as a methyl group) or an alkenyl group (such as a butynyl group); an aromatic group such as a phenyl group; or a group which contains a bivalent linear hydrocarbon group (e.g., a methylene group) one end of which is bonded to one out of the carbon atoms which constitute the lactone ring, and an aromatic group (e.g., a phenyl group) bonded to the other end of this linear hydrocarbon group. The aromatic group may further contain a substituent such as a methyl group.

R³ and R⁴ in the formulae (I-a) to (I-e) are constituents of a part of a group having a cyclic structure composed of R³, R⁴, and the carbon atoms which are bonded to both of R³ and R⁴ and are constituents of the lactone ring, wherein the group having the cyclic structure represents a cyclic hydrocarbon group having 3 to 20 carbon atoms in which a cyclic structure composed of R³, R⁴, and the carbon atoms which are bonded to both of R³ and R⁴ and are constituents of the lactone ring, forms a 3-membered to 8-membered ring when (D) R³ and R⁴ are bonded to each other. The cyclic hydrocarbon group more preferably has 3 to 12 carbon atoms.

The cyclic hydrocarbon group is, for example, a group having a cyclohexane ring structure, such as cyclohexylidene. The group may further contain a substituent.

R⁵ and R⁶ in the formulae (I-a) to (I-c) each represent a hydrogen, or a hydrocarbon group having 1 to 20 carbon atoms when (E) R⁵ and R⁶ are not bonded to each other (provided that when one of the carbon atoms which are constituents of the lactone ring and an atom of R⁵ (or R⁶) which is directly bonded to this carbon atom form a double bond, R⁶ (or R⁵) is not present). The hydrocarbon group more preferably has 1 to 12 carbon atoms.

Examples of the hydrocarbon group that can be selected as R⁵ or R⁶ include groups exemplified as the hydrocarbon group that can be selected as R³ or R⁴ in the item (C).

R⁵ and R⁶ in the formulae (I-a) to (I-c) are constituents of a part of a group having a cyclic structure composed of R⁵, R⁶, and the carbon atoms which are bonded to both of R⁵ and R⁶ and are constituents the lactone ring, wherein the group having the cyclic structure represents a cyclic hydrocarbon group having 3 to 20 carbon atoms in which a cyclic structure composed of R⁵, R⁶, and the carbon atoms which are bonded to both of R⁵ and R⁶ and are constituents of the lactone ring, forms a 3-membered to 8-membered ring when (F) where R⁵ and R⁶ are bonded to each other. The cyclic hydrocarbon group more preferably has 3 to 12 carbon atoms.

Examples of the cyclic hydrocarbon group include the same cyclic hydrocarbon groups as exemplified in the item <D>.

Specific examples of the condensed cyclic lactone compound include exemplified compounds (A-1) to (A-25) illustrated below. However, the condensed cyclic lactone compound in the invention is not limited to these examples.

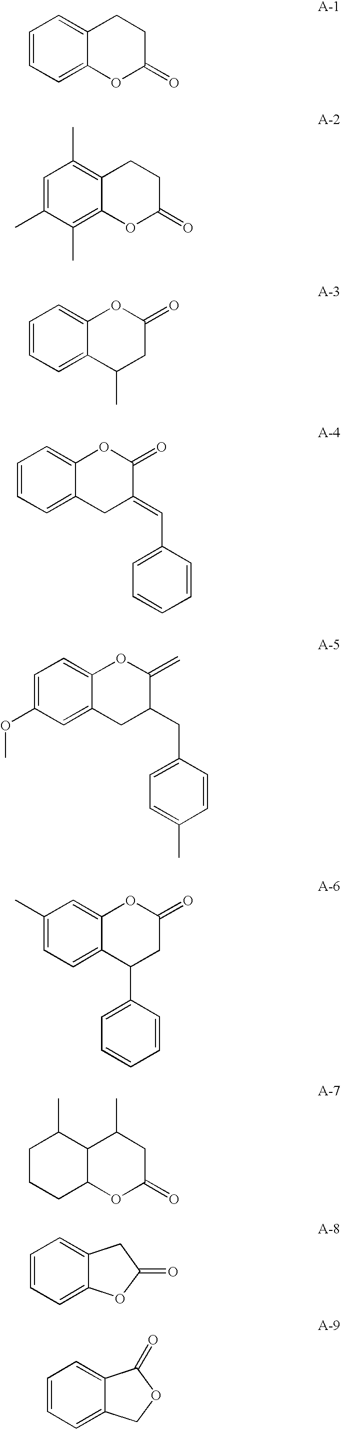

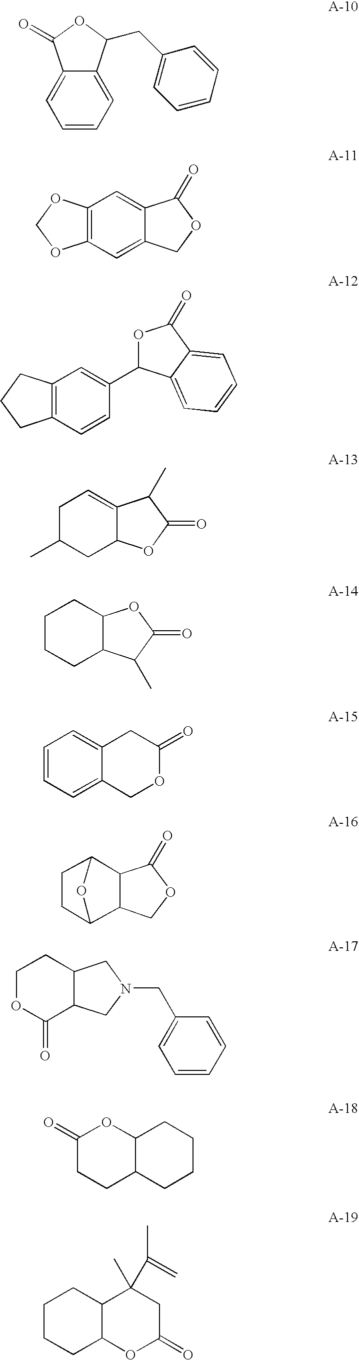

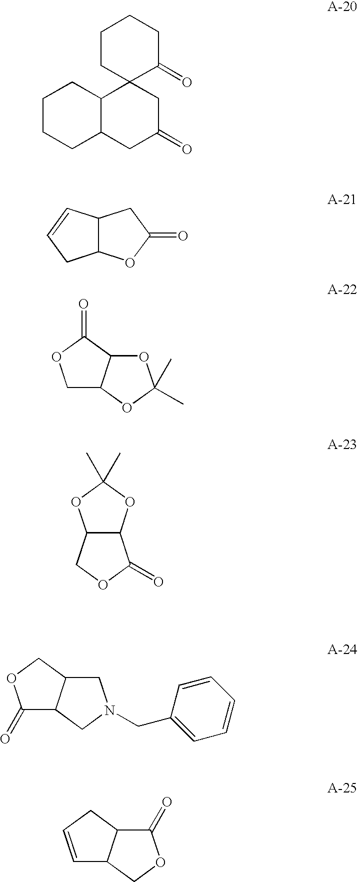

In the case of using at least an epoxy compound as the cationically polymerizable compound, compounds wherein the condensed ring has a benzene ring structure are preferred among the above-mentioned exemplified compounds from the viewpoint of the cation polymerizability with this epoxy compound. Out of these compounds, the exemplified compounds (A-1), (A-8) and (A-9) are more preferable, and the exemplified compound (A-1) [3,4-dihydrocoumarin] is in particular preferable.

About the condensed cyclic lactone compound, a single species thereof may be used, or two or more species thereof may be used together.

The content by percentage of the condensed cyclic lactone compound in the ink composition of the invention is preferably from 20 to 70 wt %, more preferably from 25 to 60 wt %, and still more preferably from 30 to 50 wt % on the basis of the total solid content in the ink composition from the viewpoint of the pigment dispersibility of the composition.

From the viewpoint of the film strength of the polymerization product, the condensed cyclic lactone compound is contained preferably in an amount of 10 to 80 parts by weight, more preferably in an amount of 15 to 60 parts by weight, and still more preferably in an amount of 20 to 50 parts by weight with respect to a total of 100 parts by weight of the total of the ink composition.

[(b) Compound that Generates Acid by Irradiation with Radiation Ray]

The ink composition according to the present invention contains a compound that generates an acid when irradiated with a radiation ray (a photo-acid generator). The photo-acid generator that can be used in the present invention include the compounds such as a photocationically polymerizable photoinitiator, a photoradically polymerizable photoinitiator, a photodecolorant to colorants, a photoalterant, or a compound that generates an acid when irradiated with light such as the light used for microresist (ultraviolet light at a wavelength of 400 to 200 nm, far ultraviolet ray, particularly preferably, g-ray, h-ray, i-ray, or KrF excimer laser beam), ArF excimer laser beam, electron beam, X-ray, molecular or ion beam, or the like.

Examples of the photo-acid generators include the compounds which are decomposed generate an acid when irradiated with a radiation ray, such as onium salt compounds such as diazonium salts, phosphonium salts, sulfonium salts, and iodonium salts, sulfonate compounds such as imidosulfonates, oximesulfonates, diazodisulfones, disulfones, and o-nitrobenzylsulfonates, and the like.

Other examples of the compounds that generate an acid when irradiated with a radiation ray or other activated light used in the present invention include the diazonium salts described in S. I. Schlesinger, Photogr. Sci. Eng., 18, 387 (1974), T. S. Bal et al., Polymer, 21, 423 (1980), and others; the ammonium salts described in U.S. Pat. Nos. 4,069,055, 4,069,056, and U.S. Reissue Pat. No. 27,992, JP-A No. 3-140,140, and others; the phosphonium salts described in D. C. Necker et al., Macromolecules, 17, 2468 (1984), C. S. Wen et al., Teh, Proc. Conf Rad. Curing ASIA, p. 478 Tokyo, October (1988), U.S. Pat. Nos. 4,069,055 and 4,069,056, and others; the iodonium salts described in J. V. Crivello et al., Macromolecules, 10(6), 1307 (1977), Chem. & Eng. News, Nov. 28, p. 31 (1988), EP Nos. 104,143, 339,049, and 410,201, JP-A Nos. 2-150848 and 2-296514, and others;

the sulfonium salts described in J. V. Crivello et al., Polymer J. 17, 73 (1985), J. V. Crivello et al., J. Org. Chem., 43, 3055 (1978), W R. Watt et al., J. Polymer Sci., Polymer Chem. Ed., 22, 1789 (1984), J. V. Crivello et al., Polymer Bull., 14, 279 (1985), J. V. Crivello et al, Macromolecules, 14(5), 1141 (1981), J. V. Crivello et al., J. Polymer Sci., Polymer Chem. Ed., 17, 2877 (1979), EP Nos. 370,693, 161,811, 410,201, 339,049, 233,567, 297,443, and 297,442, U.S. Pat. Nos. 3,902,114, 4,933,377, 4,760,013, 4,734,444, and 2,833,827, German Patent Nos. 2,904,626, 3,604,580, and 3,604,581, JP-A Nos. 7-28237 and 8-27102, and others;

the selenonium salts described in J. V. Crivello et al., Macromolecules, 10(6), 1307 (1977), J. V. Crivello et al., J. Polymer Sci., Polymer Chem. Ed., 17, 1047 (1979), and others;

the onium salts such as arsonium salts described in C. S. Wen et al., Teh, Proc. Conf. Rad. Curing ASIA, p. 478 Tokyo, October (1988), and others; the organic halogen compounds described in U.S. Pat. No. 3,905,815, JP-B No. 46-4605, JP-A Nos. 48-36281, 55-32070, 60-239736, 61-169835, 61-169837, 62-58241, 62-212401, 63-70243, and 63-298339, and others; the organic metals/organic halides described in K. Meier et al., J. Rad. Curing, 13(4), 26 (1986), T. P. Gill et al., Inorg. Chem., 19, 3007 (1980), D. Astruc, Acc. Chem. Res., 19 (12), 377 (1896), JP-A No. 2-161445, and others;

the photo-acid generators containing an O-nitrobenzyl protecting group described in S. Hayase et al., J. Polymer Sci., 25, 753 (1987), E. Reichmanis et al., J. Polymer Sci., Polymer Chem. Ed., 23, 1 (1985), Q. Q. Zhu et al., J. Photochem., 36, 85, 39, 317 (1987), B. Amit et al., Tetrahedron Lett., (24) 2205 (1973), D. H. R. Barton et al., J. Chem. Soc., 3571 (1965), P. M. Collins et al., J. Chem. Soc., Perkin 1, 1695 (1975), M. Rudinstein et al., Tetrahedron Lett., (17), 1445 (1975), J. W Walker et al., J. Am. Chem. Soc., 110, 7170 (1988), S. C. Busman et al., J. Imaging Technol., 11(4), 191 (1985), H. M. Houlihan et al., Macromolecules, 21, 2001 (1988), P. M. Collins et al., J. Chem. Soc., Chem. Commun., 532 (1972), S. Hayase et al., Macromolecules, 18, 1799 (1985), E. Reichmanis et al., J. Electrochem. Soc., Solid State Sci. Technol., 130 (6), F. M. Houlihan et al., Macromolecules, 21, 2001 (1988), EP Nos. 0290,750, 046,083, 156,535, 271,851, and 0,388,343, U.S. Pat. Nos. 3,901,710 and 4,181,531, JP-A Nos. 60-198538 and 53-133022, and others; and

the sulfonic compounds that photodecompose to generate an acid such as iminosulfonates described in M. Tunooka et al., Polymer Preprints Japan, 35 (8), G. Berner et al., J. Rad. Curing, 13 (4), W J. Mijs et al., Coating Technol., 55 (697), 45 (1983), Akzo, H. Adachi et al., Polymer Preprints Japan, 37(3), EP Nos. 0199,672, 84515, 044,115, 618,564, and 0101,122, U.S. Pat. Nos. 4,371,605 and 4,431,774, JP-A Nos. 64-18143, 2-245756, and 3-140109, and others; the disulfonated compounds described in JP-A Nos. 61-166544 and 2-71270, and others; and the diazoketosulfone and diazodisulfonated compounds described in JP-A Nos. 3-103854, 3-103856, and 4-210960 and others.

In addition, compounds having a group generating acid by the light described above or polymers having such a compound in the main chain or on the side chain including those described in M. E. Woodhouse et al., J. Am. Chem. Soc., 104, 5586 (1982), S. P. Pappas et al., J. Imaging Sci., 30 (5), 218 (1986), S. Kondo et al., Macromol. Chem., Rapid Commun., 9, 625 (1988), Y Yamada et al., Macromol. Chem., 152, 153, 163 (1972), J. V. Crivello et al., J. Polymer Sci., Polymer Chem. Ed., 17, 3845 (1979), U.S. Pat. No. 3,849,137, German Patent No. 3914407, JP-A Nos. 63-26653, 55-164824, 62-69263, 63-146038, 63-163452, 62-153853, and 63-146029, and others, may also be used. Examples thereof include onium salts such as diazonium salts, ammonium salts, phosphonium salts, iodonium salts, sulfonium salts, selenonium salts, and arsonium salts; organic halogen compounds, organic metals/organic halides, o-nitrobenzyl protecting group-containing photo-acid generators, sulfonic compounds that generates an acid by photochemical decomposition such as iminosulfonates, disulfonated compounds, diazoketosulfones, and diazodisulfonated compounds.

The compounds that generate an acid by light described in V. N. R. Pillai, Synthesis, (1), 1 (1980), A. Abad et al., Tetrahedron Lett., (47) 4555 (1971), D. H. R. Barton et al., J. Chem. Soc., (C), 329 (1970), U.S. Pat. No. 3,779,778, EP No. 126,712, and others may also be used.

Favorable examples of the photo-acid generators to be used in the invention include the compounds represented by the following Formulae (b-1), (b-2), and (b-3).

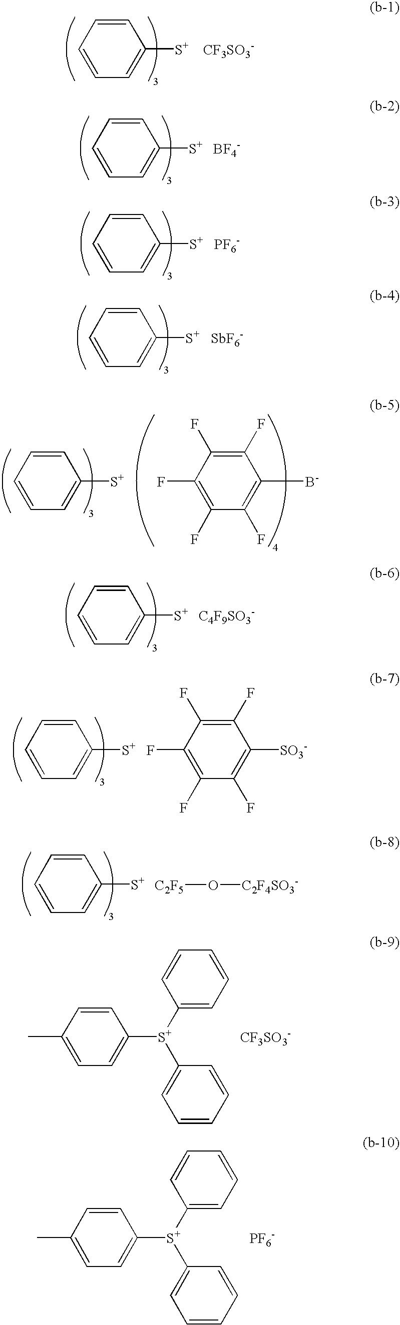

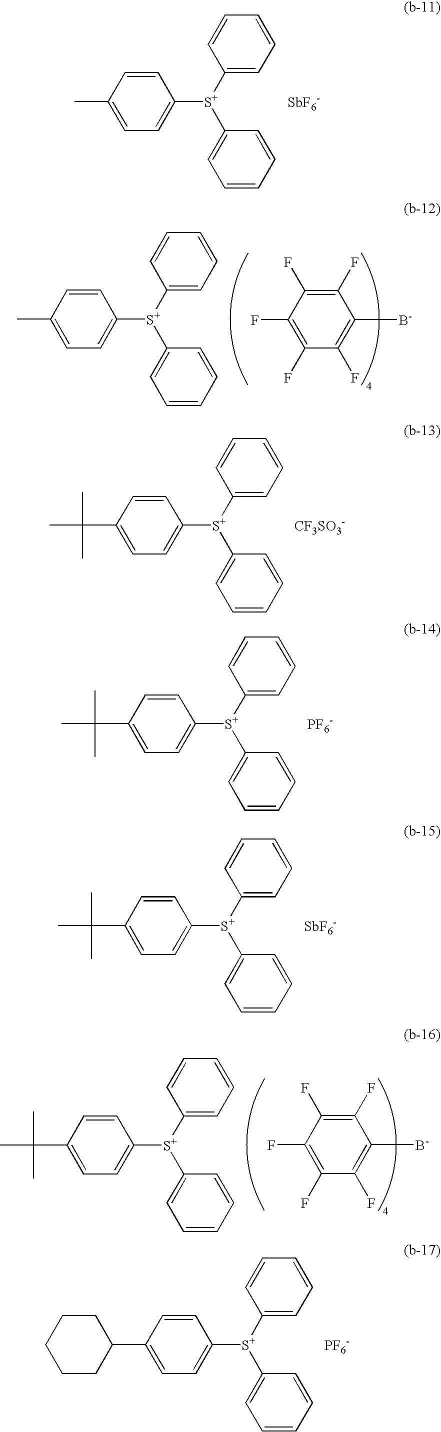

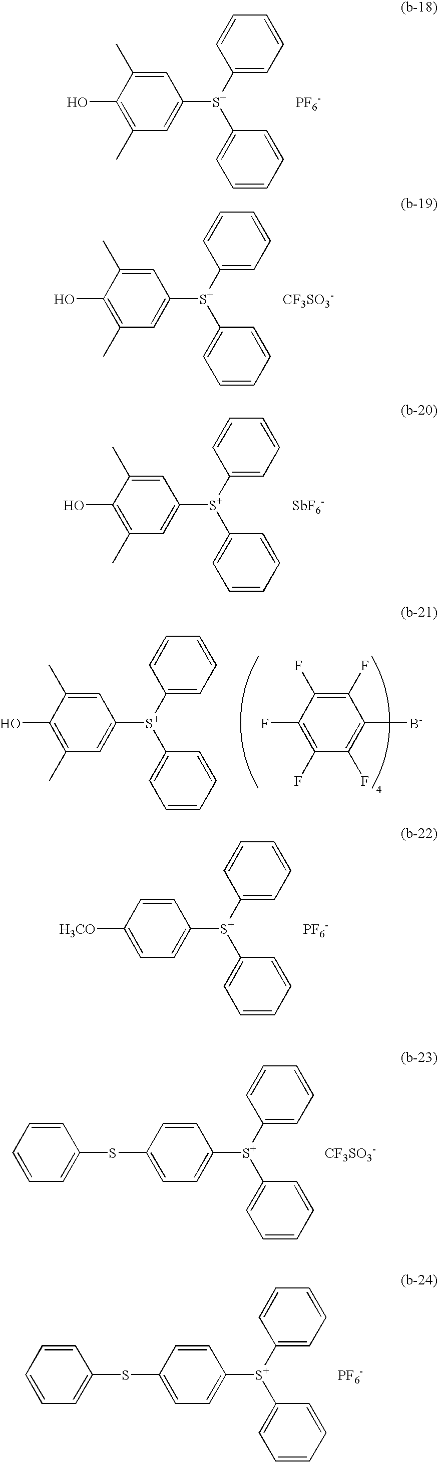

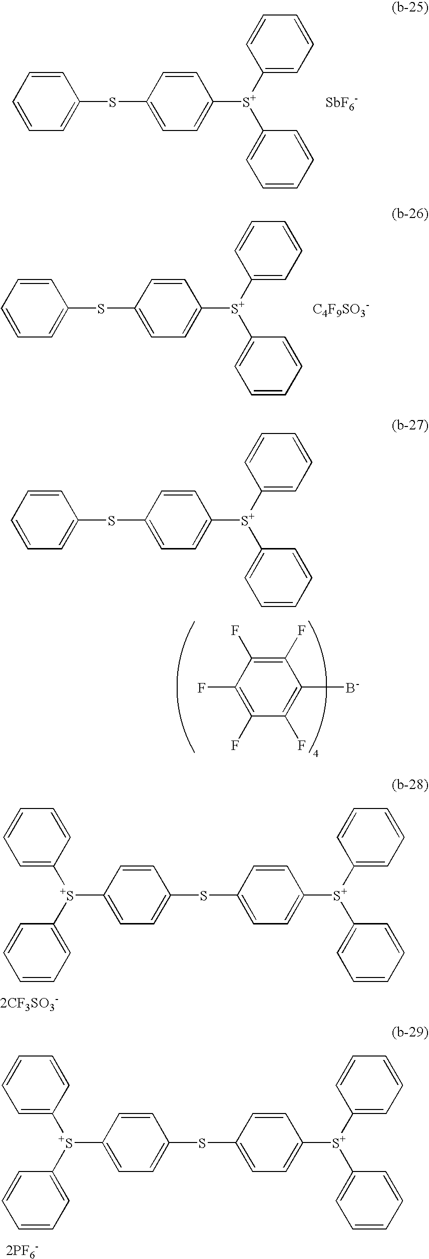

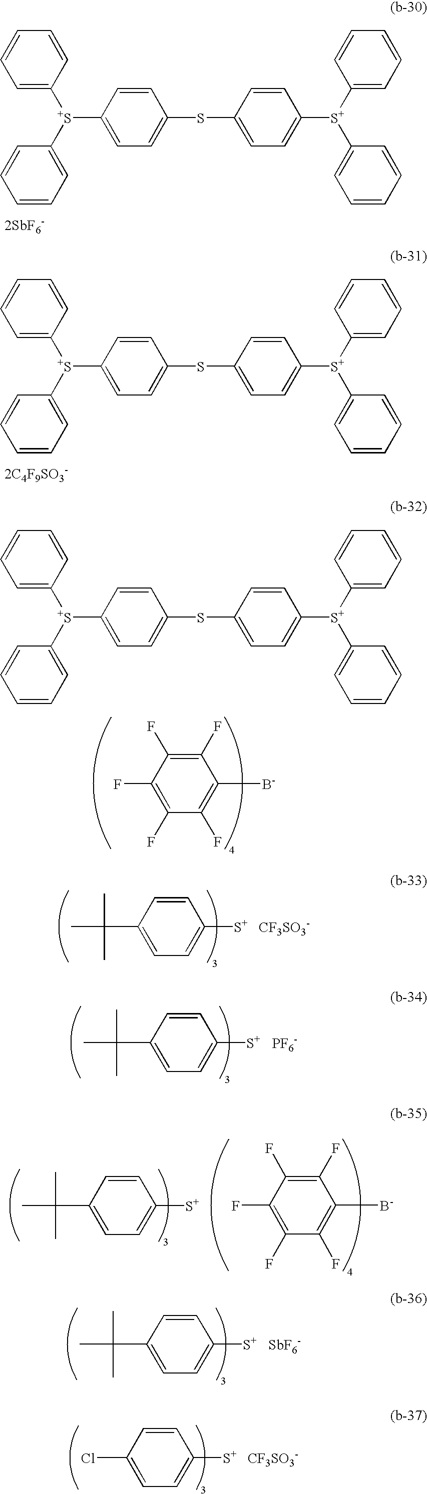

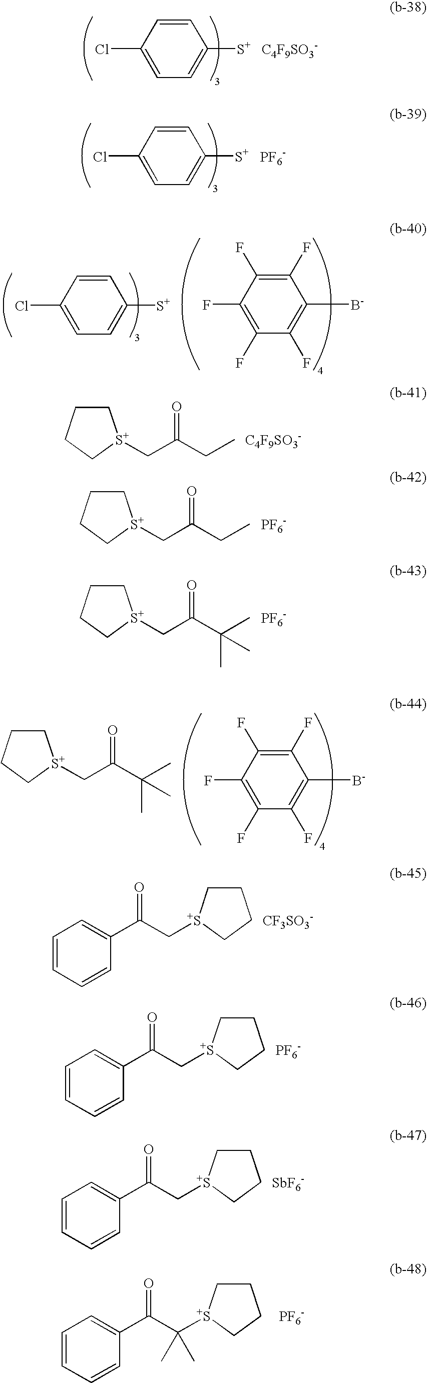

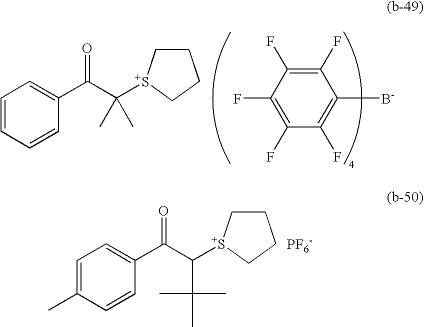

The photo-acid generator that can be used in the invention may be preferably selected from oxazole derivatives and s-triazine derivatives described in JP-A No. 2002-122994, paragraphs [0029] to [0030] besides the above-mentioned compounds.

Onium salt compounds and sulfonate compounds exemplified in JP-A No. 2002-122994, paragraphs [0037] to [0063] can also be preferably used.

About the compound (b), which is irradiated with a radiation ray to generate an acid, in the ink composition of the invention, a single species thereof may be used, or two or more species thereof may be used together.

The content of the compound (b), which is irradiated with a radiation ray to generate an acid, by percentage in the ink composition is preferably from 0.1 to 20 wt %, more preferably from 0.5 to 10 wt %, and still more preferably from 1 to 7 wt % on the basis of the total solid content in the ink composition.

The total solid content in the ink composition of the invention means components contained in the ink composition other than a solvent and any optional liquid component that will be described later.

[(c) Cationically Polymerizable Compound]

The cationically polymerizable compound (c) used in the invention is not particularly limited, as long as it is curable in the polymerization reaction initiated by the acid generated from a photo-acid generated from a compound which generates an acid by irradiation ray) a photo acid generator (b)) described above, and any one of various cationically polymerizable monomers known as photocationically polymerizable monomers may be used. Examples of the cationically polymerizable monomers include epoxy, vinyl ether, and oxetane compounds described in JP-A Nos. 6-9714, 2001-31892, 2001-40068, 2001-55507, 2001-310938, 2001-310937, 2001-220526.

The epoxy compound is, for example, an aromatic epoxide, an alicyclic epoxide or the like. Examples of the aromatic epoxide include a di- or poly-glycidyl ether prepared by reacting a polyvalent phenol having at least one aromatic nucleus or an alkylene oxide adduct thereof with an epichlorohydrin, such as di- or poly-glycidyl ethers of bisphenol A or an alkylene oxide adduct thereof, di- or poly-glycidyl ethers of hydrogenated bisphenol A or an alkylene oxide adduct thereof, and novolak epoxy resins. Examples of the alkylene oxides here include ethylene oxide and propylene oxide.

Preferable examples of the alicyclic epoxide include a cylcohexene oxide- or cyclopentene oxide-containing compound, which is prepared by epoxidizing a compound having at least one cycloalkane ring such as cyclohexene or cyclopentene with a suitable oxidizing agent such as hydrogen peroxide or peracid.

The aliphatic epoxide may be, for example, a di- or poly-glycidyl ether of an aliphatic polyvalent alcohol or the alkylene oxide adduct thereof, and examples thereof include alkylene glycol diglycidyl ethers such as ethylene glycol diglycidyl ether, propylene glycol diglycidyl ether, and 1,6-hexanediol diglycidyl ether; polyvalent alcohol polyglycidyl ethers such as di- or tri-glycidyl ether of glycerin or an alkylene oxide adduct thereof, polyalkylene glycol diglycidyl ethers such as diglycidyl ethers of polyethylene glycol or an alkylene oxide adduct thereof and diglycidyl ethers of polypropylene glycol or an alkylene oxide adduct thereof, and the like. The alkylene oxides are, for example, ethylene oxide, propylene oxide, and the like.

Examples of the monofunctional epoxy compounds used in the invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxide decane, epichlorohydrin, 1,2-epoxydecane, styrene oxide, cylcohexene oxide, 3-methacryloyloxymethylcylcohexene oxide, 3-acryloyloxymethylcylcohexene oxide, 3-vinylcyclohexene oxide and the like.

Examples of the multifunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resins, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexanecarboxylate, methylene-bis(3,4-epoxycyclohexane), dicyclopentadiene diepoxide, ethylene glycol di(3,4-epoxycyclohexylmethyl)ether, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, 1,2,5,6-diepoxycyclooctane, and the like.

Among these epoxy compounds, aromatic and alicyclic epoxides are preferable and alicyclic epoxides are particularly preferable, from the viewpoint of curing speed.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether; mono-vinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenylether-o-propylene carbonate, dodecyl vinyl ether, diethylene glycol monovinyl ether, and octadecyl vinyl ether; and the like.

Examples of the monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxy butyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, phenoxypolyethylene glycol vinyl ether and the like.

Examples of the multifunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ethers, and bisphenol F alkylene oxide divinyl ethers; multifunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, ethylene oxide adducts of trimethylolpropane trivinyl ether, propylene oxide adducts of trimethylolpropane trivinyl ether, ethylene oxide adducts of ditrimethylolpropane tetravinyl ether, propylene oxide adducts of ditrimethylolpropane tetravinyl ether, ethylene oxide adducts of pentaerythritol tetravinyl ether, propylene oxide adducts of pentaerythritol tetravinyl ether, ethylene oxide adducts of dipentaerythritol hexavinyl ether, and propylene oxide adducts of dipentaerythritol hexavinyl ether; and the like.

The vinyl ether compound is preferably a di- or tri-vinyl ether compound and particularly preferably a divinyl ether compound, from the viewpoint of curability, adhesiveness to the recording medium, and surface hardness of the formed image.

The oxetane compound according to the invention is a compound having an oxetane ring compound, and any one of known oxetane compounds, for example those described in JP-A Nos. 2001-220526, 2001-310937, and 2003-341217 may be used.

The compound having an oxetane ring used in the ink composition of the present invention is preferably a compound having one to four oxetane rings in its structure. By using such a compound, viscosity of the ink composition may be effectively controlled in a range at which adhesiveness between the hardened ink and the recording medium is favorable in terms of handling.

Examples of the compounds having one or two oxetane rings in the molecule include the compounds represented by the following Formulae (1) to (3), and the like.

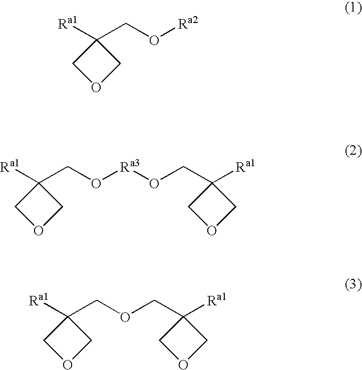

In Formulae (1) to (3), R^{a1} represents a hydrogen atom, an alkyl group having 1 to 6 carbon atoms, a fluoroalkyl group having 1 to 6 carbon atoms, an allyl group, an aryl group, a furyl group or a thienyl group. When there are two of Ra1 in the molecule, they may be the same or different from each other.

Examples of the alkyl group include methyl group, ethyl group, propyl group and butyl group, or the like, and examples of the fluoroalkyl group include the above alkyl groups in which any one of hydrogen atoms is substituted with a fluorine atom.

R^{a2} represents a hydrogen atom, an alkyl group having 1 to 6 carbon atoms, an alkenyl group having 2 to 6 carbon atoms, a group having an aromatic ring, an alkylcarbonyl group having 2 to 6 carbon atoms, an alkoxycarbonyl group having 2 to 6 carbon atoms, or an N-alkylcarbamoyl group having 2 to 6 carbon atoms. Examples of the alkyl groups include methyl, ethyl, propyl, and butyl groups and the like; examples of the alkenyl groups include i-propenyl, 2-propenyl, 2-methyl-1-propenyl, 2-methyl-2-propenyl, 1-butenyl, 2-butenyl, and 3-butenyl groups and the like; and examples of the groups having an aromatic ring include phenyl, benzyl, fluorobenzyl, methoxybenzyl, and phenoxyethyl groups and the like. Examples of the alkylcarbonyl groups include ethylcarbonyl, propylcarbonyl, and butylcarbonyl groups and the like; examples of the alkoxycarbonyl groups include ethoxycarbonyl, propoxycarbonyl, and butoxycarbonyl groups and the like; and examples of the N-alkylcarbamoyl groups include ethylcarbamoyl, propylcarbamoyl, butylcarbamoyl, and pentylcarbamoyl groups and the like.

R^{a3} represents a linear or branched alkylene group, a linear or branched poly(alkyleneoxy) group, a linear or branched unsaturated hydrocarbon group, a carbonyl group or a carbonyl group-containing alkylene group, a carboxyl group-containing alkylene group, a carbamoyl group-containing alkylene group, or the groups shown below. The alkylene groups are, for example, ethylene, propylene, and butylene groups; the poly(alkyleneoxy) groups are, for example, poly(ethyleneoxy) and poly(propyleneoxy) groups and the like. The unsaturated hydrocarbon groups are, for example, propenylene, methylpropenylene, and butenylene groups and the like.

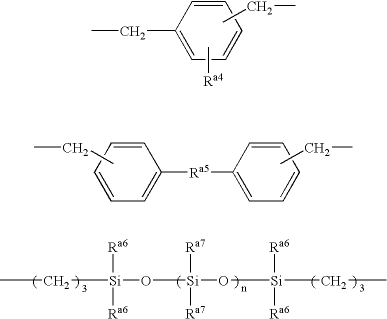

When R^{a3} is one of the polyvalent groups above, R^{a4} represents a hydrogen atom, an alkyl group having 1 to 4 carbon atoms, an alkoxy group having 1 to 4 carbon atoms, a halogen atom, a nitro group, a cyano group, a mercapto group, a lower alkylcarboxyl group, a carboxyl group, or a carbamoyl group.

R^{a5} represents an oxygen or sulfur atom, a methylene group, NH, SO, SO2, C(CF3)2, or C(CH3)2.

R^{a6} represents an alkyl group having 1 to 4 carbon atoms or an aryl group; and n is an integer of 0 to 2,000. R^{a7} represents an alkyl group having 1 to 4 carbon atoms, an aryl group, or a monovalent group having the structure shown below. In the following Formula, R^{a8} is an alkyl group having 1 to 4 carbon atoms or an aryl group; and m is an integer of 0 to 100.

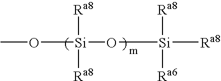

Examples of the compounds having three or four oxetane rings include the compounds represented by the following Formula (4).

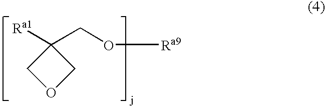

In Formula (4), R^{a1} is the same definition as that in Formula (I) above. Examples of R^{a9}, a polyvalent connecting group, include a branched alkylene group having 1 to 12 carbon atoms such as the group represented by the following Formula A, B, or C, a branched poly(alkyleneoxy) group such as the group represented by the following Formula D, a branched polysiloxy group represented by the following Formula E, or the like. j is 3 0r 4.

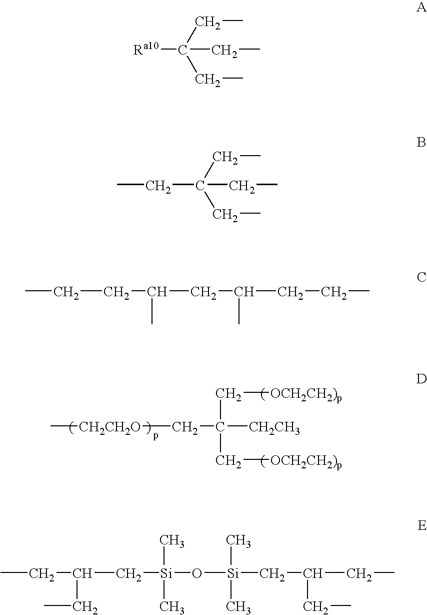

In Formula A, R^{a10} represents a methyl, ethyl or propyl group, and in Formula D, p is an integer of 1 to 10.

Other examples of the oxetane compounds favorably used in the present invention include the compounds having oxetane rings on the side chains represented by the following Formula (5).

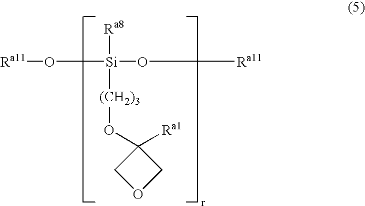

In Formula (5), R^{a8} is the same definition as that in the Formula above. R^{a11} represents an alkyl group having 1 to 4 carbon atoms, such as methyl, ethyl, propyl or butyl, or a trialkylsilyl group; and r is 1 to 4.

Such compounds having oxetane rings are described specifically in JP-A No. 2003-341217, paragraph [0021] to [0084], and the compounds described therein can be used favorably in the invention.

Among the oxetane compounds used in the present invention, a compound having one oxetane ring is preferable, from the viewpoint of viscosity and tackiness of the ink-composition.

These cationically polymerizable compounds may be used alone or in combination of two or more thereof in the ink composition of the invention. It is preferable that at least an epoxy compound is used since the composition can be cured with a higher sensitivity by irradiation with a radiation ray and further the strength of the film obtained by the curing can be made better. In order to obtain the above-mentioned advantageous effects more remarkably, the condensed cyclic lactone compound and the epoxy compound are contained in the ink composition of the invention at a ratio by weight preferably in a range of 1:2 to 2:1, more preferably in a range of 2:3 to 3:2. Most preferably, they are contained therein at a ratio by weight of 1:1. Details of the mechanism of the action of exhibiting this advantageous effect are unclear, but it is presumed that when the composition is irradiated with a radiation ray, the alternating copolymerizability of the condensed cyclic lactone compound with the epoxy compound is high.

The use of such a blend ratio is particularly preferable when the exemplified compound (A-1), (A-8) or (A-9) is used as the condensed cyclic lactone compound, and is most preferable when the exemplified compound (A-1) is used.

On the other hand, it is preferable to use at least one compound selected from the oxetane and epoxy compounds and a vinyl ether compound in combination, from the view point of effectively preventing shrinkage during curing of ink.

The content of the cationically polymerizable compound (c) in the ink composition is appropriately in a range of 10 to 95 wt %, preferably 30 to 90 Wt %, and still more preferably 50 to 85 wt %, in proportion to the total solid content of the ink composition.

In addition to the essential components mentioned above, various additives may be added to the ink composition according to the invention. These optional components added as needed will be described hereinafter.

[(d) Colorant]

By adding a colorant in the ink composition of the present invention, a visible image can be formed. For example, although addition of colorant is not necessarily needed for forming an image region on a planographic printing plate, it is also preferable from the viewpoint of efficiency for plate-checking of the obtained planographic printing plate.

The colorant that can be used is not particularly limited, and any known colorants of various kinds (pigments or dyes) may be selected and used as appropriate according to usage. For example, use of a pigment is preferable for forming an image superior in weather resistance. As a dye, both water-soluble and oil-soluble dyes may be used, but the oil soluble dye is preferable.

The pigments favorably used in the invention will be described below.

(Pigment)

The pigment is not particularly limited, and examples thereof include all common commercially-available organic and inorganic pigments, dispersions of the pigments dispersed in a dispersion medium such as an insoluble resin, pigments with a surface on which a resin is grafted, and the like. Alternatively, for example, resin particles colored with a dye may also be used.

Such pigments include the pigments described, for example, in Seijiro Itoh Ed., “Dictionary of Pigments” (2000), W Herbst K. Hunger, Industrial Organic Pigments”, and JP-A Nos. 2002-12607, 2002-188025, 2003-26978, and 2003-342503.

Typical examples of the organic and inorganic pigments to be used in the invention include the followings:

Yellow pigments, e.g., monoazo pigments such as C.I. Pigment Yellow 1 (Fast Yellow G, etc.) and C.I. Pigment Yellow 74; disazo pigments such as C.I. Pigment Yellow 12 (Disazo Yellow AAA, etc.) and C.I. Pigment Yellow 17; non-benzidine azo pigments such as C.I. Pigment Yellow 180; azolake pigments such as C.I. Pigment Yellow 100 (tartrazine yellow lake, etc.); condensation azo pigments such as C.I. Pigment Yellow 95(Condensation Azo Yellow GR, etc.); acidic-dye lake pigments such as C.I. Pigment Yellow 115 (quinoline yellow lake, etc.); basic-dye lake pigments such as C.I. Pigment Yellow 18 (thioflavin lake, etc.); anthraquinone pigments such as fravantrone yellow (Y-24); isoindolinone pigments such as Isoindolinone Yellow 3RLT (Y-110); quinophthalone pigments such as quinophthalone yellow (Y-138); isoindoline pigments such as isoindoline yellow (Y-139); nitroso pigments such as C.I. Pigment Yellow 153 (nickel nitroso yellow, etc.); metal complex salt azomethine pigments such as C.I. Pigment Yellow 117 (copper azomethine yellow, etc.); and the like.

Red or magenta pigments, e.g., monoazo pigments such as C.I. Pigment Red 3 (toluidine red, etc.); disazo pigments such as C.I. Pigment Red 38 (pyrazolone red B, etc.); azolake pigments such as C.I. Pigment Red 53:1 (lake red C, etc.) and C.I. Pigment Red 57:1 (Brilliant Carmine 6B); condensation azo pigments such as C.I. Pigment Red 144 (Condensation Azo Red BR, etc.); acidic-dye lake pigments such as C.I. Pigment Red 174 (Phloxine B lake, etc.); basic dye lake pigments such as C.I. Pigment Red 81 (Rhodamine 6G′ Lake, etc.); anthraquinone pigments such as C.I. Pigment Red 177 (dianthraquinolyl red, etc.); thioindigo pigments such as C.I. Pigment Red 88 (Thioindigo Bordeaux, etc.); perynone pigments such as C.I. Pigment Red 194 (perynone red, etc.); perylene pigments such as C.I. Pigment Red 149 (perylene scarlet, etc.); quinacridone pigments such as C.I. Pigment Violet 19 (unsubstituted quinacridone) and C.I. Pigment Red 122 (quinacridone magenta, etc.); isoindolinone pigments such as C.I. Pigment Red 180 (Isoindolinone Red 2BLT, etc.); alizarin lake pigments such as C.I. Pigment Red 83 (madder lake, etc.); and the like.

Blue or cyan pigments, e.g., disazo pigments such as C.I. Pigment Blue 25 (dianisidine blue, etc.); phthalocyanine pigments such as C.I. Pigment Blue 15 (phthalocyanine blue, etc.); acidic-dye lake pigments such as C.I. Pigment Blue 24 (peacock blue lake, etc.); basic dye lake pigments such as C.I. Pigment Blue 1 (Victria Pure Blue BO lake, etc.); anthraquinone pigments such as C.I. Pigment Blue 60 (indanthron blue, etc.); alkali blue pigments such as C.I. Pigment Blue 18 (Alkali Blue V-5:1); and the like.

Green pigments, e.g., phthalocyanine pigments such as C.I. Pigment Green 7 (phthalocyanine green) and C.I. Pigment Green 36 (phthalocyanine green); azo metal complex pigments such as C.I. Pigment Green 8 (nitroso green); and the like.

Orange pigments, e.g., isoindoline pigments such as C.I. Pigment Orange 66 (isoindoline orange); anthraquinone pigments such as C.I. Pigment Orange 51 (dichloropyranthron orange); and the like.

Black pigments, e.g., carbon black, titanium black, aniline black, and the like.

White pigments, e.g., basic lead carbonate (2PbCO3Pb(OH)2, so-called silver white), zinc oxide (ZnO, so-called zinc white), titanium oxide (TiO2, so-called titanium white), strontium titanate (SrTiO3, so-called titanium strontium white), and the like.

Titanium oxide has a lower density and a higher refractive index, and further superior chemical and physical stability as compared with other white pigments, thus having a greater masking and coloring properties as a pigment, and is excellent in resistance to acid or alkali and other environmental factors. Thus, use of titanium oxide as the white pigment is preferable. Other white pigments (including white pigments other than those described above) may also be used as needed.

For dispersing the pigment, dispersing machines may be used, such as a ball mill, sand mill, attritor, roll mill, jet mill, homogenizer, paint shaker, kneader, agitator, Henschel mixer, colloid mill, ultrasonic wave homogenizer, pearl mill, and a wet jet mill. A dispersant may also be added at the time of dispersing a pigment.

Examples of the dispersants include hydroxyl group-containing carboxylic esters, salts of a long-chain polyaminoamide with a high-molecular acid ester, high-molecular polycarboxylic acid salts, high-molecular unsaturated acid esters, copolymers, modified polyacrylates, aliphatic polyvalent carboxylic acids, naphthalenesulfonic acid/formalin condensates, polyoxyethylene alkyl phosphoric esters, pigment derivatives, and the like. Use of a commercially available polymer dispersant, such as a Solsperse series product of Zeneca, is also preferable.

It is also possible to use a synergist suitable for the pigment used as the dispersion aid. These dispersants and dispersion aids are preferably added in an amount of 1 to 50 parts by weight relative to 100 parts by weight of the pigment.

As a dispersion medium for the components such as a pigment in the ink composition, a solvent may be added, or the cationically polymerizable compound (a), being a low-molecular weight component, may be used without solvent. However, since the ink composition of the present invention is radiation-curable and is cured after application on a recording medium, the ink preferably contains no solvent. This is because the solvent remaining in the hardened ink image may cause deterioration in solvent resistance or problems of VOC (Volatile Organic Compound) of the residual solvent. In view of this, the dispersion medium is preferably a cationically polymerizable compound (a), and selecting a cationic-polymerization monomer with the lowest viscosity is particularly preferable from the viewpoint of improving dispersibility and handling efficiency of the ink composition.

The average diameter of the pigment is preferably in a range of 0.02 to 0.4 μm, more preferably 0.02 to 0.1 μm, and still more preferably 0.02 to 0.07 μm.

The pigment, dispersant, and dispersion medium are selected and conditions of dispersion and filtration are determined such that the average diameter of the pigment particles is within the above preferable range. Control of particle diameter enables prevention of clogging in head nozzles and retaining of storage stability, transparency and curing sensitivity of the ink.

The colorant is preferably added in an amount of 1 to 20 wt %, more preferably 2 to 10 wt %, in proportion to the total solid content of the ink composition.

(Dye)

The dye used in the present invention is preferably oil-soluble. Specifically, the dye preferably has solubility in water (represented by the weight of the colorant dissolved in 100 g of water) of 1 g or less at 25° C., preferably 0.5 g or less, and more preferably 0.1 g or less. Accordingly, so-called water-insoluble and oil-soluble dyes are favorably used.

The oil-soluble dye preferably has a melting point of 200° C. or lower, more preferably 150° C. or lower, and still more preferably 100° C. or lower. Use of a low-melting point oil-soluble dye enables restriction of crystal precipitation of the colorant in the ink composition and improvement in storage stability of the ink composition.

The dye preferably has a high oxidation potential, in terms of improving resistance to deterioration of color, and in particular to oxidative substances such as ozone. Thus, the oil-soluble dye used in the present invention preferably has an oxidation potential of 1.0 V or more (vs. SCE). Higher oxidation potential is preferable, thus a dye having an oxidation potential of 1.1 V or more (vs. SCE) is more preferable, and that of 1.15 V or more (vs. SCE) is particularly preferable.

As the yellow dyes, compounds having a structure of Formula (Y-T) described in JP-A No. 2004-250483 are preferable.

Example of particularly preferable yellow dyes include the dyes represented by Formulae (Y-II) to (Y-IV) in JP-A No. 2004-250483, paragraph [0034], and specific examples thereof include the compounds described in JP-A No. 2004-250483, paragraph [0060] to [0071]. The oil-soluble dyes represented by Formula (Y-I) described therein may be used not only in yellow ink, but also in inks of any other colors such as black and red.

As the magenta dyes, compounds having the structures represented by Formulae (3) and (4) in JP-A No. 2002-114930 are preferable, and typical examples thereof include the compounds described in JP-A No. 2002-114930, paragraph [0054] to [0073].

Particularly preferable magenta dyes are the azo dyes represented by Formulae (M-1) to (M-2) in JP-A No. 2002-121414, paragraph [0084] to [0122], and typical examples thereof include the compounds described in JP-A No. 2002-121414, paragraph [0123] to [0132]. The oil-soluble dyes represented by Formulae (3), (4), and (M-1) to (M-2) may be used not only in magenta ink, but also in inks of any other colors such as black and red inks.

As the cyan dyes, compounds represented by Formulae (I) to (IV) in JP-A No. 2001-181547 and the dyes represented by Formulae (IV-1) to (IV-4) in JP-A No. 2002-121414, paragraph [0063] to [0078], and specific examples thereof include the compounds described in JP-A2001-181547, paragraph [0052] to [0066] and in JP-A2002-121414, paragraph [0079] to [0081].

Particularly preferable cyan dyes are the phthalocyanine dyes of Formulae (C-I) and (C-II) described in JP-A No. 2002-121414, paragraph [0133] to [0196], and still more preferable are the phthalocyanine dyes represented by Formula (C-II). Specific examples thereof include the compounds described in JP-A No. 2002-121414, paragraph [0198] to [0201]. The oil-soluble dyes represented by Formulae (I) to (IV), (IV-1) to (IV-4), (C-I), and (C-II) may be used not only in cyan ink, but also in inks of any other colors such as black and green inks.

As for the dyes to be used in the present invention, it is also preferable to introduce an oil-solubilizing group in the core of the dyes described above, to ensure that the necessary amount of dye is dissolved in the ink composition.

Examples of the oil-solubilizing groups include long-chain branched alkyl groups, long-chain branched alkoxy groups, long-chain branched alkylthio groups, long-chain branched alkylsulfonyl groups, long-chain branched acyloxy groups, long-chain branched alkoxycarbonyl groups, long-chain branched acyl groups, long-chain branched acylamino groups, long-chain branched alkylsulfonylamino groups, long-chain branched alkylaminosulfonyl groups, as well as aryl, aryloxy, aryloxycarbonyl, arylcarbonyloxy, arylaminocarbonyl, arylaminosulfonyl, and arylsulfonylamino groups containing these long-chain branched substituent groups, and the like.

Alternatively, conversion of an oil-solubilizing group may be performed, such as alkoxycarbony, aryloxycarbonyl, alkylaminosulfonyl or arylaminosulfonyl, on water-soluble dyes having carboxylic acid or sulfonic acid groups, by using a long-chain branched alcohol, amine, phenol, or aniline derivative.

### —Oxidation Potential—

The oxidation potential value (Eox) of the dye in the invention can be easily determined by those skilled in the art. These methods are described, for example, in P. Delahay, “New Instrumental Method in Electrochemistry” (1954, Interscience Publishers), A. J. Bard et al., “Electrochemical Methods” (1980, John Wiley & sons), and Akira Fujishima et al., “Electrochemical Measurement Methods” (1984, Gihodo Shuppan).

Specifically, the oxidation potential value is measured by dissolving a test sample at a concentration of 1×10-2 to 1×10-6 mole/liter in a solvent such as dimethylformamide or acetonitrile containing a supporting electrolyte such as sodium perchlorate or tetrapropylammonium perchlorate. An oxidation wave is obtained applying a voltage to the anodic side (higher side), using carbon (GC) as the working electrode and a revolving platinum electrode as the counter electrode in a cyclic voltametric or direct-current polarographic apparatus, then the oxidation wave is approximated by a straight line. Intersecting points of the straight line of oxidation wave and a straight line of residual current-potential, and the straight line of oxidation wave and a straight line of saturated current (or a straight line that is parallel to the vertical line that passes through the peak of electric potential) are calculated. The medium voltage at the center of the line connecting the two intersecting points is measured as the value against SCE (saturated calomel electrode). The value may deviate to a certain extent, approximately by several dozen millivolts, under the influence of the difference in voltage between the liquids or the liquid resistivity of the sample solution, but it is possible to assure the reproducibility of the electric potential by using a standard sample (e.g., hydroquinone). The supporting electrolyte and the solvent for use may be selected as appropriate according to the oxidation potential and solubility of the test sample. The supporting electrolyte and the solvent for use are described in Akira Fujishima et al., “Electrochemical Measurement Methods” (1984, Gihodo Shuppan) pp. 101 to 118.

[Other Components]

In the ink composition of the present invention, in addition to the essential components (a) to (c) and an optional colorant (d), various known additives that are used in an ink composition may be used as appropriate according to usage, as long as advantages of the present invention is not hindered.

In the following, a variety of additives that are used as needs arise will be described.

### [Compounds Having Basic Nitrogen Atom]

In the invention, for the purpose of improving the storage stability of the ink composition, a compound having a basic nitrogen atom (hereinafter, appropriately referred to as particular base component) may be contained, if desired. The compound preferably has a basic nitrogen atom, and the pKa of a conjugate acid thereof is 4 or more. A pKa value stipulated here is determined as the value obtained by attaching a minus sign to a natural logarithm of the dissociation constant Ka of a weak electrolyte in an aqueous solution, i.e., pKa=−log₁₀ Ka.

Examples of such compounds include: anilines such as 2-chloroaniline, 2-bromoaniline, 4-methylaniline, 3-chroloaniline, 3,5-dibromoaniline, N-methylaniline, N,N-dimethylaniline, N,N-diethylaniline, N,N-bis(hydroxyethyl)aniline, 3-nitroaniline, 2-aminobenzoic acid, 4-aminoazobenzene, N-phenylaniline and N-phenylglycine; pyridines such as 3-chloropyridine, 3-bromopyridine, 4-hydroxypyridine, 3-carboxypyridine, 2,6-dimethylpyridine and 2,4,6-trimethylpyridine; cyclic amines such as proline, hydroxyproline, purine, 8-hydroxypurine, N-methylpyrazine, thiazole and tryptophan; aliphatic amino acids such as arginine, aspartic acid, glutamic acid, N-methylglycine, N-propylglycine, histidine, cystine, leucine, isoleucine, ornithine, serine, threonine, methionine, alanine and methoxyalanine; and aliphatic tertiary amines such as trimethylamine, triethylamine, tributylamine, diisopropylethylamine and trioctylamine. Additionally, compounds having a 1,3-diazapropene structure can be specifically cited. However, as long as the compound has a basic nitrogen atom in the molecular structure, they are not restricted to the examples. Still more preferred examples thereof include compounds represented by Formulae (X) to (XIII).

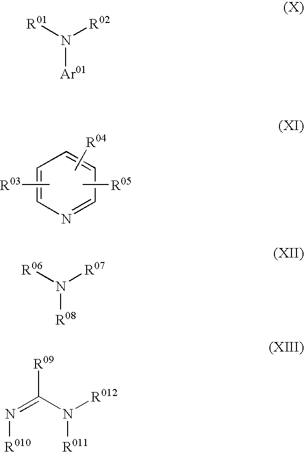

In Formulae (X) to (XIII), R⁰¹ and R⁰² each independently represent a hydrogen atom or an alkyl group, cycloalkyl group, aralkyl group or aryl group that may be substituted or not, and Ar01 represents an aryl group that may be substituted or not. R⁰³ to R⁰⁵ each independently represent a hydrogen atom or an alkyl group, cycloalkyl group, aralkyl group, aryl group, hydroxyl group, carboxyl group, cyano group, nitro group, acyl group or —N(R⁰¹)(R⁰²) group that may be substituted or not. R⁰⁶ to R⁰⁸ and R⁰¹⁰ to R⁰¹² each independently represent a hydrogen atom or an alkyl group, cycloalkyl group or aralkyl group that may be substituted or not. R⁰⁹ represents an alkyl group, cycloalkyl group, aralkyl group, aryl group, —N(R⁰¹³)(R⁰¹⁴) group, or —OR⁰¹⁵ group that may be substituted or not. R⁰¹³ to R⁰¹⁵ each independently represent a hydrogen atom, or an alkyl group, cycloalkyl group, or aralkyl group that may be substituted or not. Furthermore, R⁰¹ and R⁰² in Formula (X), any two of R⁰³ to R⁰⁵ in Formula (XI), any two of R⁰⁶ to R⁰⁸ in Formula (XII), or any two of R⁰⁹ to R⁰¹⁵ in Formula (XIII) may be bonded with each other to form an aliphatic ring, an aromatic ring or a hetero ring.

The alkyl group, cycloalkyl group, aralkyl group, aryl group and substituent groups that can be introduced therein are the same as those described in the case of the Formulae (I) to (IX).

As the particular base component, specifically, compounds (X-1) to (XIII-12) below can be cited. However, the invention is not restricted thereto.

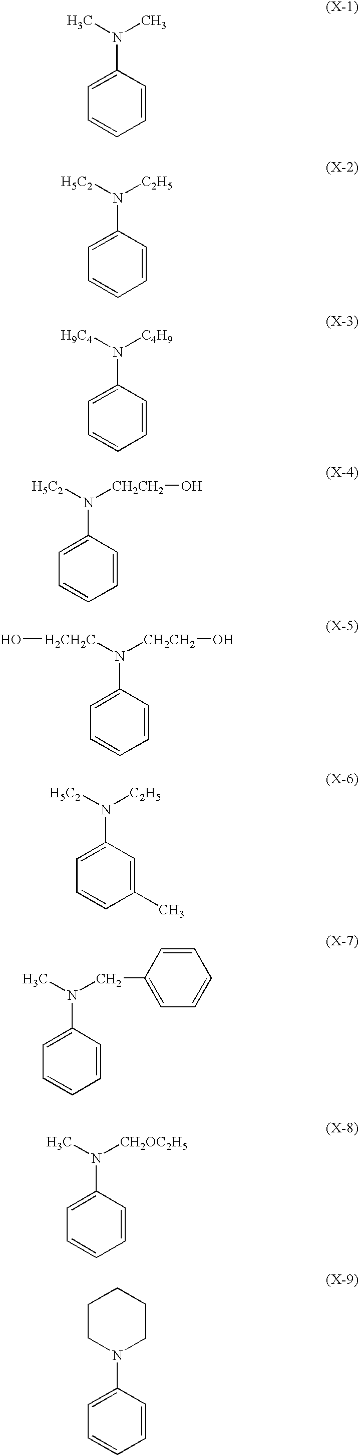

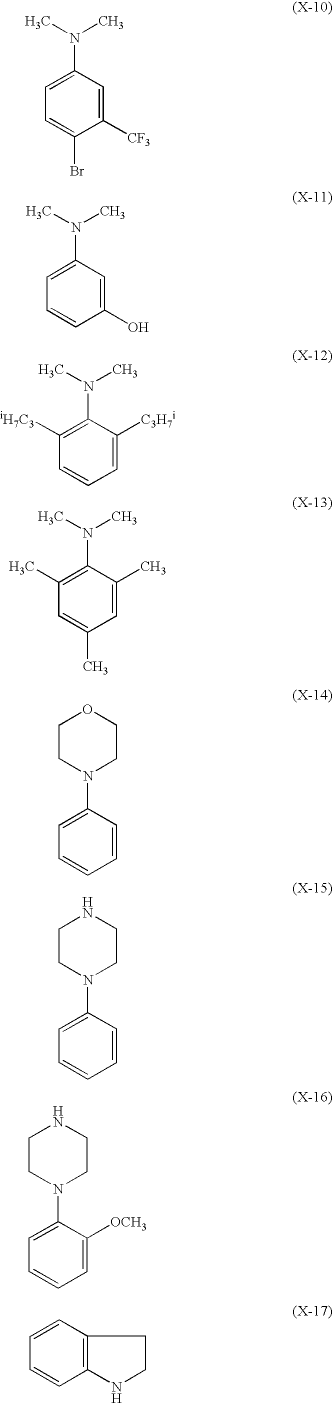

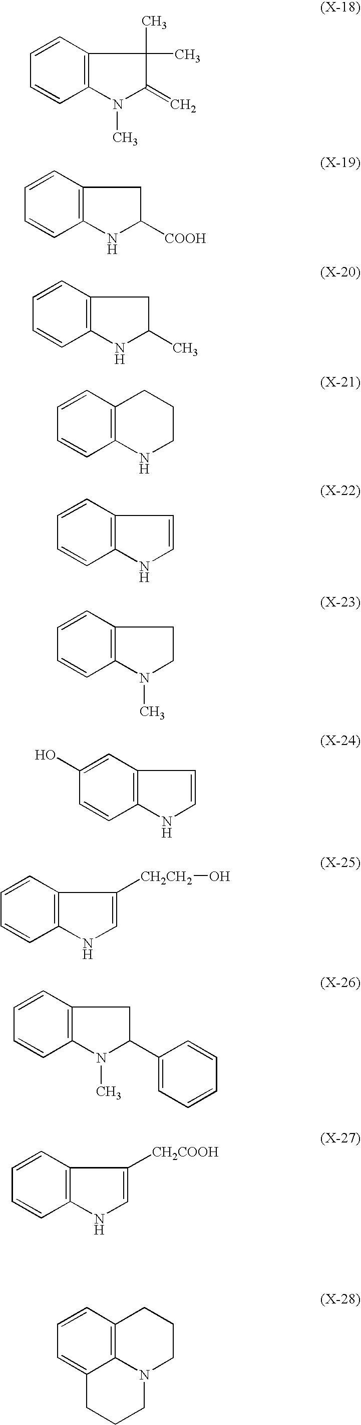

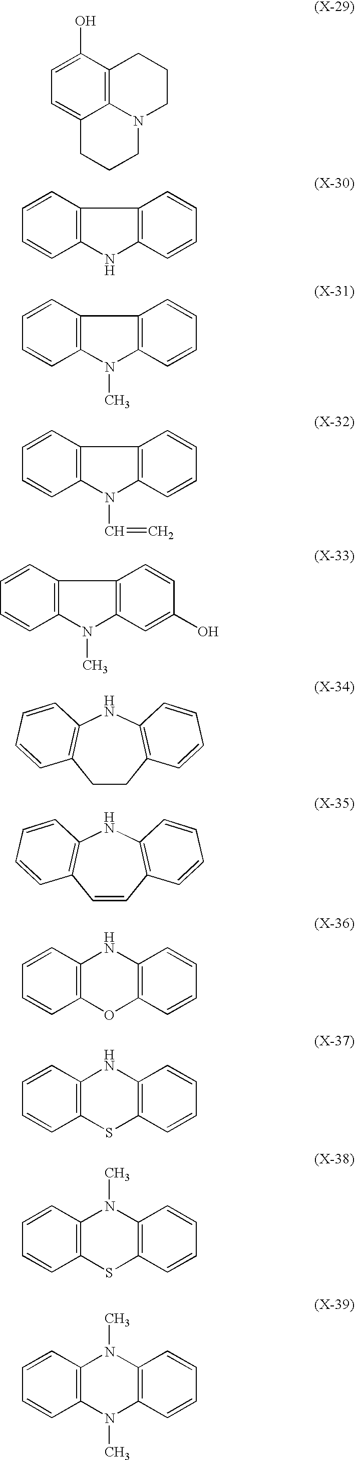

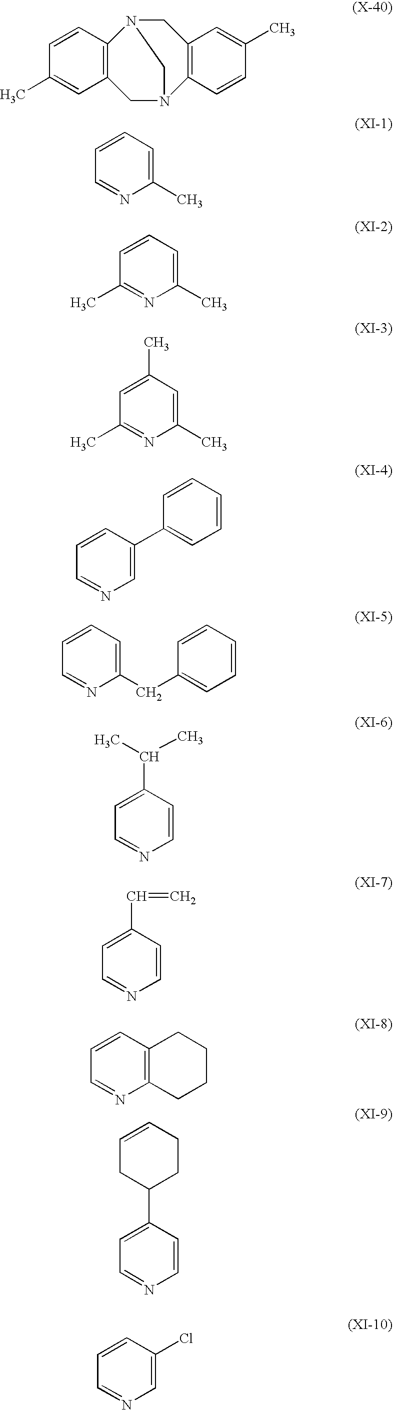

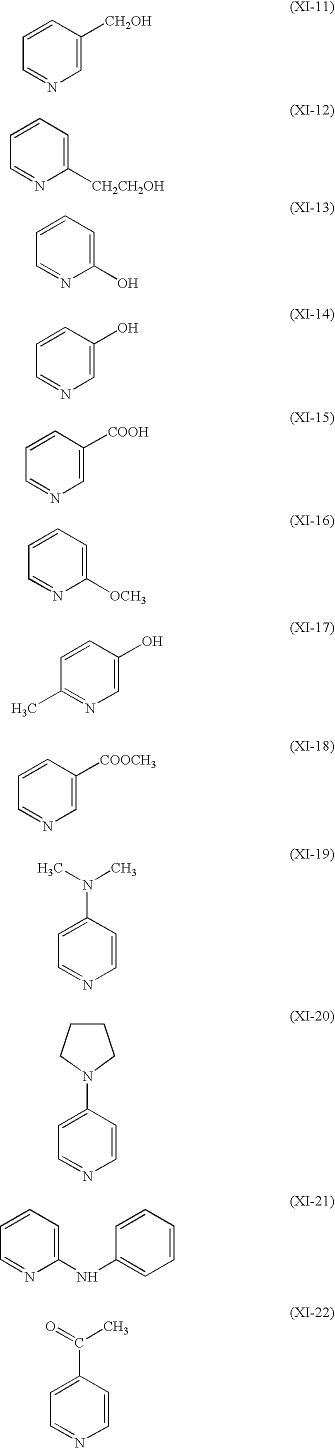

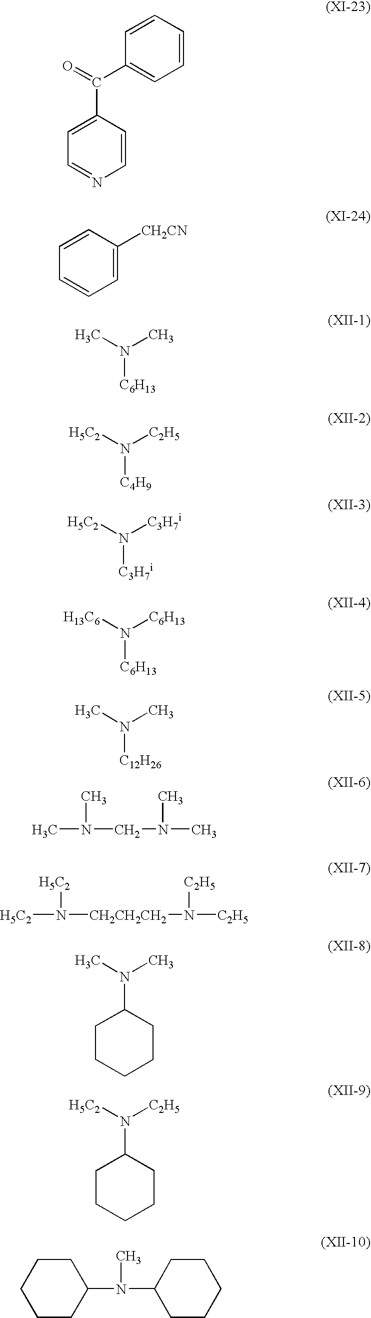

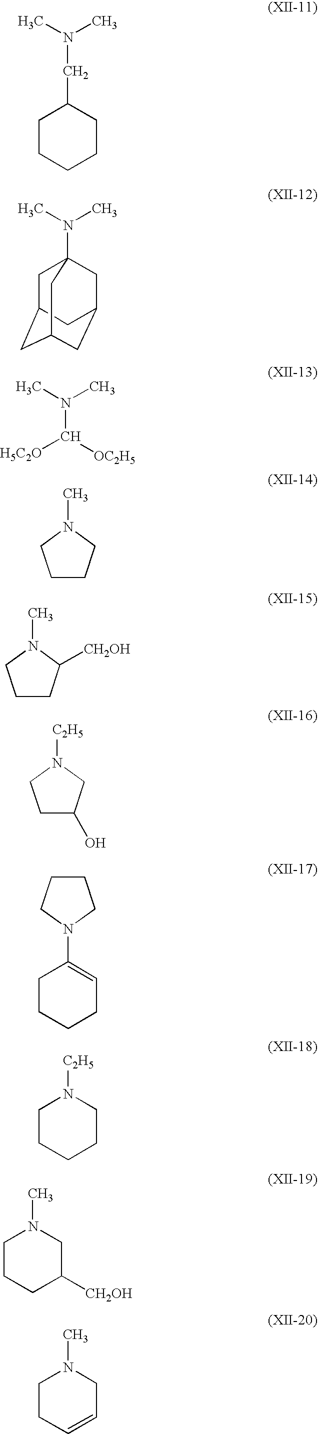

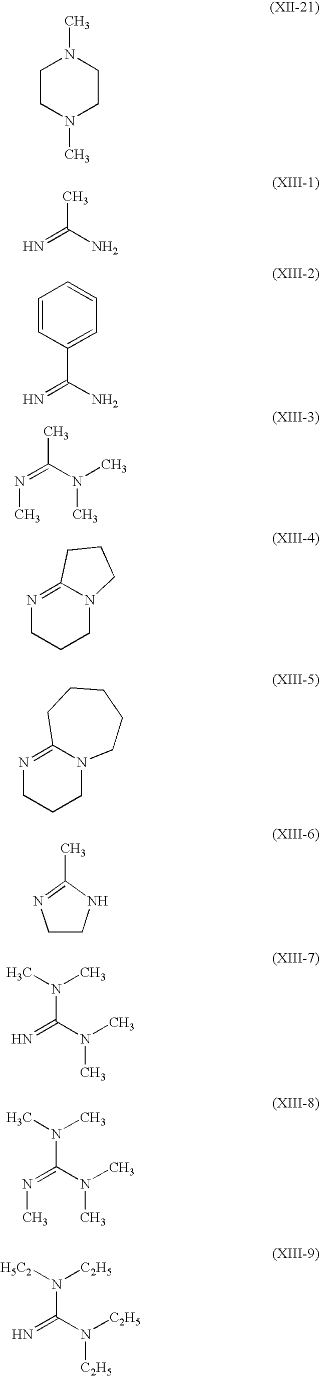

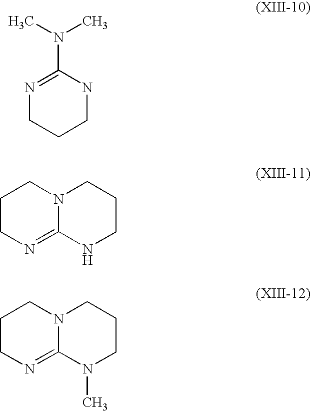

In the ink composition of the invention, only one kind of the particular base component may be added or may be in combination of two or more kinds. A content of the particular base component in the ink composition is, in proportion to a total solid content of the composition, suitably in a range of 0.001 to 10% by weight, preferably in a range of 0.01 to 7% by weight and more preferably in a range of 0.03 to 5% by weight. Furthermore, the ratio to the compound that generates an acid by irradiation of a radiation ray (b) is in a range of 0.1 to 50% by mole, and preferably in a range of 0.5 to 20% by mole.

[Organic Acidic Compound Showing pKa Value of 2 to 6]

In the invention, as appropriate, an organic acidic compound having a pKa of 2 to 6 may be further used. The organic acidic compound that shows the pKa value of 2 to 6 (hereinafter, simply referred to as [organic acidic component]) corresponds to a weak acidic organic compound, from the qualitative point of view. When the pKa is in the above range, the ink composition of the invention is excellent in sensitivity and stability with time.

Specific examples of the specific compounds include, in particular, carboxylic acids such as aliphatic or aromatic monocarboxylic acids, dicarboxylic acids and tricarboxylic acids having 1 to 20 carbon atoms such as acetic acid, phenyl acetic acid, phenoxy acetic acid, methoxy propionic acid, lactic acid, hexanoic acid, heptanoic acid, octanoic acid, palmitic acid, stearic acid, oleic acid, linolenic acid, cyclopropylcarboxylic acid, cyclobutanecarboxylic acid, cyclopentanecarboxylic acid, cyclohexanecarboxylic acid, 1-adamantanecarboxylic acid, 1,3-adamantanedicarboxylic acid, norbornen-2,3-dicarboxylic acid, abietic acid, trans-retinoic acid, cyclohexylacetic acid, dicyclohexylacetic acid, adamantaneacetic acid, malonic acid, malonic acid monomethyl ester, fumaric acid, maleic acid, maleic acid monomethyl ester, itaconic acid, crotonic acid, succinic acid, adipic acid, sebacic acid, glycolic acid, diglycolic acid, mandelic acid, tartaric acid, malic acid, arginic acid, cinnamic acid, methoxycinnamic acid, 3,5-dimethoxycinnamic acid, benzoic acid, salicylic acid, 4-hydroxybenzoic acid, gallic acid, 3-nitrobenzoic acid, 3-chlorobenzoic acid, 4-vinylbenzoic acid, t-butylbenzoic acid, 1-naphthoic acid, 1-hydroxy-2-naphthoic acid, fluorenone-2-carboxylic acid, 9-anthracenecarboxylic acid, 2-anthraquinonecarboxylic acid, phthalic acid, phthalic acid monomethyl ester, isophthalic acid, terephthalic acid, trimellitic acid, and trimellitic acid monomethyl ester. However, the invention is not restricted thereto.

When the organic acidic component is used in the ink composition of the invention, a content thereof in proportion to a total solid content of the ink composition is preferably in a range of 0.001 to 10% by weight, more preferably in a range of 0.01 to 7% by weight and still more preferably in a range of 0.05 to 5% by weight. Furthermore, when the particular base component is used, the ratio of the particular base component and the organic acidic component is preferably in a range of 0.1 to 4 and more preferably in a range of 0.3 to 2 by molar ratio of (particular base component)/(organic acidic component).

[Ultraviolet Absorbent]

An ultraviolet absorbent may be added to the ink composition of the invention, for improvement in weather fastness and prevention of discoloration of the obtained image.

Examples of the ultraviolet absorbents include the benzotriazole compounds described in JP-A Nos. 58-185677, 61-190537, 2-782, 5-197075 and 9-34057 and others; the benzophenone compounds described in JP-A Nos. 46-2784 and 5-194483, U.S. Pat. No. 3,214,463, and others; the cinnamic acid compounds described in JP-B Nos. 48-30492 and 56-21141, JP-A No. 10-88106, and others; the triazine compounds described in JP-A Nos. 4-298503, 8-53427, 8-239368, 10-182621 and 8-501291, and others; the compounds described in Research Disclosure No. 24239; compounds that emit light by absorbing ultraviolet ray such as stilbene and benzoxazole compounds; so-called fluorescent brighteners; and the like. The addition amount may be suitably determined according to usage, but is generally 0.5 to 15 wt % on the basis of the solid content in the ink composition.

(Sensitizer)

A sensitizer may be added to the ink composition according to the invention, for improvement in acid-generating efficiency of photo-acid generator and for a longer wavelength for exposure. The sensitizer is not particularly limited, as long as it sensitizes the photo-acid generator in the electron- or energy-transfer mechanism. Favorable examples thereof include aromatic fused-ring compounds such as anthracene, 9,10-dialkoxyanthracene, pyrene and perylene; aromatic ketone compounds such as acetophenone, benzophenone, thioxanthone and Michler's ketone; and heterocyclic ring compounds such as phenothiazine and N-aryloxasolidinones. The addition amount can be decided as appropriate according to usage, but generally 0.01 to 1 mol %, preferably 0.1 to 0.5 mol %, relative to the photo-acid generator.

(Antioxidant)

An antioxidant may be added, for improvement of stability of the ink composition. Examples of the antioxidants include those described in EP Patent Laid-Open Nos. 223739, 309401, 309402, 310551, 310552 and 459-416, German Patent Laid-Open No. 3435443, JP-A Nos. 54-48535, 62-262047, 63-113536, 63-163351, 2-262654, 2-71262, 3-121449, 5-61166, and 5-119449, U.S. Pat. Nos. 4,814,262 and 4,980,275, and others. The addition amount can be determined as appropriate according to usage, but generally 0.1 to 8 wt % on the basis of the solid content in the ink composition.

(Discoloration Inhibitor)

Any one of various organic and metal complex-based discoloration inhibitors may be used in the ink composition according to the invention. Examples of the organic discoloration inhibitor include hydroquinones, alkoxyphenols, dialkoxyphenols, phenols, anilines, amines, indanes, chromanes, alkoxyanilines, heterocyclic rings, and the like. Examples of the metal complex-based discoloration inhibitors include nickel complexes, zinc complexes, and the like; Specific examples thereof include the compounds described in the patents cited in Research Disclosure No. 17643 (sections VII-I to J), ibid., No. 15162, ibid., No. 18716 (left column on p. 650), ibid., No. 36544 (p. 527), ibid., No. 307105 (p. 872), and ibid., No. 15162; and the compounds included in the Formula of typical compounds and the exemplary compounds described in JP-A No. 62-215272, pp. 127 to 137. The addition amount can be determined as appropriate according to usage, but generally 0.1 to 8 wt % on the basis of the solid content in the ink composition.

(Conductive Salt)

A conductive salt such as potassium thiocyanate, lithium nitrate, ammonium thiocyanate, or dimethylamine hydrochloride may be added to the ink composition according to the invention, for control of the physical properties during ejection.

(Solvent)

Addition of a very slight amount of organic solvent to the ink composition according to the invention is effective for improvement in adhesiveness to the recording medium.

Examples of the solvents include ketone solvents such as acetone, methylethylketone, and diethylketone; alcohol solvents such as methanol, ethanol, 2-propanol, 1-propanol, 1-butanol, and tert-butanol; chlorine-based solvents such as chloroform and methylene chloride; aromatic solvents such as benzene and toluene; ester solvents such as ethyl acetate, butyl acetate, and isopropyl acetate; ether solvents such as diethyl ether, tetrahydrofuran, and dioxane; glycol ether solvents such as ethylene glycol monomethyl ether and ethylene glycol dimethyl ether; and the like.

When a solvent is used, the amount of the solvent added is in a range that does not cause problems such as solvent resistance and VOC, and thus, preferably in a range of 0.1 to 5 wt %, more preferably 0.1 to 3 wt %, in the entire ink composition.

[Polymer Compound]

Various polymer compounds may be added to the ink composition, for adjustment of film physical properties. Examples of the polymer compounds include acrylic polymers, polyvinylbutyral resins, polyurethane resins, polyamide resins, polyester resins, epoxy resins, phenol resins, polycarbonate resins, polyvinylbutyral resins, polyvinylformal resins, shellac, vinyl resins, acrylic resins, rubber resin, waxes, other natural resins, and the like. These resins may be used in combination of two or more. Among them, vinyl copolymers obtained by copolymerization with an acrylic monomer are preferable. In addition, copolymers containing a “carboxyl group-containing monomer”, an “alkyl methacrylate”, or an “alkyl acrylate” as the structural unit in a copolymerization component are also used favorably for the polymer binding material.

[Surfactant]

The surfactants include those described in JP-A Nos. 62-173463 and 62-183457. Examples thereof include anionic surfactants such as dialkylsulfoscuccinic acid salts, alkylnaphthalenesulfonic acid salts, and fatty acid salts; nonionic surfactants such as polyoxyethylene alkyl ethers, polyoxyethylene alkyl allyl ethers, acetylene glycols, and polyoxyethylene-polyoxypropylene block copolymers; cationic surfactants such as alkylamine salts and quaternary ammonium salts; and the like. An organic fluorine compound may be used instead of the surfactant. The organic fluorine compound is preferably hydrophobic. Examples of the organic fluorine compounds include fluorine-type surfactants, oily fluorine-type compounds (e.g., fluorine oil) and solid fluorine-type compound resins (e.g., polytetrafluoroethylene); and typical examples thereof include those described in JP-B No. 57-9053 (Columns 8 to 17) and JP-A No. 62-135826.

Other additives may also be added as appropriate, such as a leveling additive, a matting agent, a wax for adjustment of film physical properties, or a tackifier for improvement of adhesiveness to a recording medium of polyolefin, PET or the like, that does not inhibit polymerization.

Specific examples of tackifiers include high-molecular weight adhesive polymers described in JP-A 2001-49200, pp. 5 to 6 (e.g., copolymers of an ester of a (meth)acrylic acid and an alcohol with an alkyl group having 1 to 20 carbon atoms, an ester of a (meth)acrylic acid and an alicyclic alcohol having 3 to 14 carbon atoms, and an ester of a (meth)acrylic acid and an aromatic alcohol having 6 to 14 carbon atoms), and low-molecular weight adhesive imparting resins containing a polymerizable unsaturated bond, and the like.

Considering the ejection efficiency when applied to inkjet recording, the ink composition according to the invention preferably has an ink viscosity of 7 to 30 mPa·s, more preferably 7 to 20 mPa·s, at a temperature at which the ink is ejected, and thus, it is preferable to adjust and determine the composition ratio appropriately so that the viscosity falls within a range. The viscosity of the ink composition at 25 to 30° C. is preferably 35 to 500 mPa·sm, and more preferably 35 to 200 mPa·s. By increasing the viscosity at room temperature, permeation of ink into a recording medium can be prevented, even when a porous recording medium is used, thus the amount of uncured monomer and odor can be reduced. Further, ink bleeding at the time of ink droplets being ejected onto the recording medium can be suppressed, thereby improving the image quality. When the ink viscosity at 25 to 30° C. is within the above range, sufficient effects of preventing ink bleeding can be achieved, and delivery of an ink liquid is favorable.

The surface tension of the ink composition according to the invention is preferably 20 to 30 mN/m and more preferably 23 to 28 mN/m. When the ink is applied onto recording mediums of various types, such as polyolefin, PET, coated paper, and non-coated paper, the surface tension is preferably 20 mN/m or more, from the viewpoint of preventing bleeding and penetration of ink, and 30 mN/m or less, from the viewpoint of improving bleeding and penetration.

The ink composition according to the invention thus adjusted is favorably used as an inkjet recording ink. The ink composition is ejected onto a recording medium by an inkjet printer, and then the ejected ink composition is cured by irradiating a radiation ray.

The printed material obtained using the ink of the invention is superior in strength in the image area which is cured by irradiating a radiation ray such as an ultraviolet ray, and thus applicable to various uses other than formation of an image with ink, such as formation of an ink receiving layer (image area) of planographic printing plate.

[Inkjet Recording Method and Inkjet Recording Apparatus)

The inkjet recording method and the inkjet recording apparatus, that may favorably be applied to the present invention, will now be described.

The inkjet recording method of the invention is an inkjet recording method comprising:

(i) ejecting the ink composition of the invention onto a recording medium; and

(ii) curing the ejected ink composition by irradiating with a radiation ray.

The printed material of the invention is a recording material that is recorded by the inkjet recording method of the invention

In the inkjet recording method of the invention, it is preferable to heat the ink composition so that the temperature thereof is 40 to 80° C., adjusting the viscosity of the ink composition to be within 7 to 30 mPa·s, and then ejecting the ink composition In this way, a high degree of ejection stability can be achieved. Generally, radiation-curable ink compositions have higher viscosity than that of aqueous inks, and fluctuation in viscosity of the radiation-curable ink compositions is larger, due to variation in temperature during printing. Such fluctuation in viscosity of the ink composition significantly and directly influences the droplet size and the droplet ejection speed, causing deterioration in image quality. Therefore, it is necessary to keep the temperature of the ink composition as constant as possible, during printing. The range of the temperature of the ink composition to be controlled is preferably ±5° C., more preferably ±2° C., and still more preferably ±1° C., from the preset temperature.

The inkjet recording apparatus is provided with a unit for stabilizing the temperature of the ink composition, which characterizes an aspect of the invention, and area where the temperature is to be controlled include the whole piping system and all members, the area ranging from an ink tank (or an intermediate tank, if present) to a nozzle ejection face.

The method of controlling temperature is not particularly limited, but, for example, each piping unit is preferably provided with multiple temperature sensors, and heating control is performed in accordance with the flow of ink and environmental temperature. In addition, the head unit to be heated is preferably thermally insulated or protected, for prevention of the environmental influences on the apparatus. It is preferable to insulate the heating unit from other units and minimize the heat capacity of the entire heating unit, for shortening the start-up time required for heating or for reducing the loss in heat energy.

Irradiation conditions of a radiation will be now described. A basic irradiation method is disclosed in JP-A No. 60-132767. Specifically, two radiation sources are placed at both side of a head unit, and the head unit and the radiation sources are scanned in a shuttle mode. Irradiation is performed after a certain period of time from ejection of the ink composition. Further, curing of the ink composition is completed by irradiating with another radiation source that is not driven. WO 99/54415 discloses an irradiation method using an optical fiber, and a method of irradiating a recording area (region where ink composition is ejected) with UV ray, which is obtained from a collimated radiation source via a mirror surface provided on the side of head unit. These irradiation methods may be applied to the invention.

Examples of the radiation ray for irradiation is not particularly limited, as long as the radiation ray can impart energy to the aforementioned compounds ((b) component) with which the compounds, which generates an acid by irradiating a radiation ray, can be decomposed, and are active radiation rays including X ray, ultraviolet ray, visible light, and electron beam. Among these, ultraviolet ray having a wavelength of 230 to 420 nm is preferable. As a light source, a polar or non-polar mercury lamp, metal halide lamp, xenon lamp, or a light-emitting diode having the above range of wavelength (UV-LED) may be used. In the case of using a UV-LED, plural diodes are used in such a manner that they are arranged in a straight line or in three dimensions, i.e., as a multi array, by means of energy power of the light-emitting chips.

It is also preferable in the invention that the ink composition is heated to a certain degree of temperature, and the time period from ejection to irradiation is 0.01 to 0.5 second, more preferably 0.01 to 0.3 second, and still more preferably 0.01 to 0.15 second. By controlling the time period from ejection to irradiation to be extremely short, the ejected ink can be prevented from bleeding before being cured. Also, exposure can be performed before the ink penetrates into the depth where the light cannot reach, even in the case of a porous recording medium, thus remaining of the unreacted monomers can be suppressed, thereby reducing odor. The inkjet recording method as described above and the ink composition according to the invention provides a synergic effect when used in combination. Particularly effective is use of the ink composition having an ink viscosity of 35 to 500 mPa·s at 25° C. By using such a recording method, dot diameter of the ejected ink composition can be kept constant at any recording mediums of different surface compatibility, thus improving the image quality. For obtaining a color image, it is preferable that a color image having lower brightness precedes the one having higher brightness, in layering the color images. When a color image having a lower brightness is superimposed on the others, it becomes difficult for radiation ray to reach the ink in the lower part, and problems tend to occur, such as inhibition of curing sensitivity, increase in the amount of residual monomer, generation of odor, or deterioration in adhesiveness. Although irradiation may be performed on all of the color images at the same time, it is preferable to perform irradiation each time a color image is formed, from the viewpoint of facilitating the curing.

The inkjet recording apparatus to be used in the invention is not particularly limited, and any commercially available inkjet recording apparatuses can be used. That is, in the invention, by applying the ink composition of the invention onto a recording medium with an inkjet recording apparatus, an image can be recorded on the recording medium, in other words, a printed material can be obtained.

(Recording Medium)

Recording mediums, to which the ink composition according to the invention can be applied, are not particularly limited and include common papers such as non-coated and coated papers, various non-absorptive resin materials used in so-called soft packaging, and resin films formed from the non-absorptive resin materials into films; and examples of the various plastic films include a PET film, an OPS film, an OPP film, an ONy film, a PVC film, a PE film, a TAC film, and the like. Examples of the other plastics for use as the recording medium material include polycarbonate, acrylic resins, ABS, polyacetal, PVA, rubbers, and the like. In addition, metals and glasses are also usable as the recording medium.

The ink composition of the present invention is resistant to heat shrinkage during hardening and superior in adhesiveness to the base material (recording medium). Therefore, the ink composition of the present invention has an advantage of enabling formation of a high-definition image even on films that easily curl or deform due to shrinkage at the time of curing or heat during curing reaction, for example, thermally shrinkable films such as a PET film, an OPS film, an OPP film, a ONy film, and a PVC film.

[Planographic Printing Plate]

Use in a planographic printing plate is one of the favorable applications of the ink composition of the present invention. A method of producing a planographic printing plate of the present invention includes the steps of ejecting the ink composition of the present invention on a hydrophilic substrate, and forming a hydrophobic region on the hydrophilic substrate by irradiating with a radiation ray to cure the ink composition. The planographic printing plate of the present invention is a planographic printing plate obtained by the method of producing a planographic printing plate of the present invention. When an ink and an aqueous component are supplied thereto, the aqueous component is held in the region exposed on the hydrophilic substrate while the ink is held in the hydrophobic region; and the recording medium can be used as it is in the printing step.

By ejecting the ink composition of the present invention on a hydrophilic substrate using a device such as an inkjet recording apparatus, and irradiating with a radiation ray to cure the ink, an imagewise hydrophobic ink-receiving area is formed on the hydrophilic substrate. When ink and an aqueous component are supplied on the ink-receiving area, the aqueous component is retained in the region where the hydrophilic substrate is exposed, while the ink is retained in the hydrophobic image region, whereby a printing process can be directly carried out.

Because the ink composition according of the present invention exhibits superior curing sensitivity by irradiation of a radiation ray, the planographic printing plate of the present invention utilizing the ink composition has an image area having excellent printing durability. In addition, it is possible to form a high-definition image area on the planographic printing plate directly from digital data utilizing an inkjet recording method.

The ink composition of the present invention described above may be used as is, as the ink composition used in production of a planographic printing plate.

### [Substrate]

The substrate favorably used in preparation of the planographic printing plate of the present invention will now be described.

The substrate for use in preparation of the planographic printing plate according to the invention is not particularly limited, and may be any substrate as long as it is a dimensionally stable plate-shaped substrate. Any material may be directly used for the substrate, as long as it has a hydrophilic surface, or a plate-shaped substrate with a surface being subjected to a hydrophilizing treatment may also be used.

Examples of the materials for the substrate include papers, papers laminated with a plastic material (e.g., polyethylene, polypropylene, or polystyrene), metal plates (e.g., aluminum, zinc and copper), plastic films (e.g., cellulose diacetate, cellulose triacetate, cellulose propionate, cellulose butyrate, cellulose acetate butyrate, cellulose lactate, cellulose nitrate, polyethylene terephthalate, polyethylene, polystyrene, polypropylene, polycarbonate, and polyvinylacetal), papers or plastic films onto which the above-described metals are laminated or deposited, and the like. Preferable substrates include polyester film and aluminum plate. Among them, an aluminum plate, which is superior in dimensional stability and relatively low cost, is preferable.

Favorable aluminum plates are pure aluminum plates and alloy plates containing aluminum as the main component and a small amount of foreign elements, or may be a thin film of aluminum or aluminum alloy with a plastic film laminated thereon. The foreign elements contained in the aluminum alloy include silicon, iron, manganese, copper, magnesium, chromium, zinc, bismuth, nickel, and titanium. The content of the foreign element in the alloy is preferably 10 wt % or less. Although pure aluminum is most preferable in the invention, the aluminum plate may contain a small amount of foreign elements, because it is difficult to prepare completely pure aluminum due to problems in a refining process. The composition of the aluminum plate is not particularly limited, and any known raw and commonly used material may be used.

The thickness of the substrate is preferably 0.1 to 0.6 mm and more preferably 0.15 to 0.4 mm.

The aluminum plate is preferably subjected to a surface finishing treatment before use, such as surface-roughening treatment or anodizing treatment. Hydrophilicity of the recording medium and adhesion between the image-recording layer and the substrate are improved by performing surface finishing. Prior to the surface-roughening treatment, the aluminum plate is subjected to a degreasing treatment, for example, with a surfactant, organic solvent, aqueous alkaline solution, or the like, for removing rolling oil from the surface.

Various methods may be used for surface roughening of aluminum plate, and examples thereof include a mechanical surface-roughening treatment, an electrochemical surface-roughening treatment (a method of surface-roughening by electrochemically dissolving the surface), and chemical surface-roughening treatment (a method of surface-roughening by selectively dissolving the surface by a chemical treatment).

Any one of the methods known in the art such as ball polishing, brushing, blast polishing, and buffing may be used as a mechanical surface-roughening method. Alternatively, a method of transferring surface irregularity may be applied, using a surface-irregular roll during a process of hot rolling the aluminum.

The electrochemical surface-roughening may be performed, for example, by applying an alternate or direct current to the substrate in an electrolyte solution containing an acid such as hydrochloric acid or nitric acid. Yet alternatively, the method using a mixed acid described in JP-A No. 54-63902 may also be used.

The aluminum plate after surface-roughening treatment may be etched as needed by using an alkaline aqueous solution of, for example, potassium hydroxide or sodium hydroxide, and further, after neutralization, subjected to an anodizing process to improve abrasion resistance, if appropriate.

Various electrolytes that form a porous oxide film may be used as the electrolytes for anodizing an aluminum plate. Generally, sulfuric acid, hydrochloric acid, oxalic acid, chromic acid, or a mixed acid thereof is used. The concentration of the electrolyte is determined according to the kind of electrolyte as appropriate.

Conditions for the anodizing process vary according to the electrolyte used, and thus is not specified particularly; but generally, the electrolyte concentration is 1 to 80 wt %; liquid temperature is 5 to 70° C.; electric current density is 5 to 60 A/dm2; voltage is 1 to 100 V; and the electrolysis period is from 10 seconds to 5 minutes. The amount of the anodic oxide film to be formed is preferably 1.0 to 5.0 g/m2 and more preferably 1.5 to 4.0 g/m2. Within the above range, it is possible to obtain a planographic printing plate favorable in printing durability and scuff resistance in the non-image area.

The surface-finished substrate having an anodic oxide film described above may be used as the substrate for use in the present invention, but may also be subjected to other treatments as needed, for example, treatments for expanding or sealing of micropores in the anodic oxide film described in JP-A Nos. 2001-253181 and 2001-322365, or a surface hydrophilizing treatment performed by immersing the substrate in an aqueous solution containing a hydrophilic compound, for further improvement of adhesion to the upper layer, hydrophilicity, stain resistance, heat insulation efficiency, and others. The expanding and sealing treatments are not limited to the methods described above, and any known methods may be used.

(Sealing Treatment)

Sealing treatment may be performed by methods using an aqueous solution containing an inorganic fluorine compound, such as a treatment with fluorozirconic acid alone or sodium fluoride, vapor sealing in the presence of lithium chloride, or sealing with hot water.

Among the above methods, sealing treatments utilizing an aqueous solution containing an inorganic fluorine compound, water vapor, and hot-water are preferable.

[Hydrophilizing Treatment]

Hydrophilizing treatments for use in the present invention include an alkali metal silicate method described in U.S. Pat. Nos. 2,714,066, 3,181,461, 3,280,734 and 3,902,734. In this method, the substrate is immersed and electrolyzed, for example, in an aqueous solution of sodium silicate. Also included are a method of treating the substrate with potassium fluorozirconate, described in JP-B No. 36-22063, and a method of treating with polyvinylphosphonic acid, described in U.S. Pat. Nos. 3,276,868, 4,153,461 and 4,689,272.

The substrate in the invention preferably has an average center-line roughness of 0.10 to 1.2 μm. Within this range, it is possible to obtain favorable adhesiveness to the image recording layer, favorable printing durability, and favorable stain resistance.

The planographic printing plate formed by the ink composition of the present invention is easily produced based on digital data, and is useful for obtaining a large number of printings having high quality since the plate has an image region having superior printing durability.

Hereinafter, exemplary embodiments of the present invention will now be described.

### <Preparation of Pigment Dispersions.

Pigment dispersions 1 of yellow, magenta, cyan and black, respectively, were prepared according to the method described hereinafter. The dispersion was prepared by performing dispersion with a known dispersing machine, under conditions adjusted such that an average diameter of pigment particles is in a range of 0.2 to 0.3 μm, and then filtering the mixture under heat.

(Yellow Pigment Dispersion 1)

C.I. Pigment Yellow 12: 10 parts by weight
Polymeric dispersing agent (one out of SOLSPERS series, manufactured by Zeneca Co.): 5 parts by weight
Oxetane compound (trade name: OXT-221, manufactured by Toagosei Co., Ltd.): 85 parts by weight

(Magenta Pigment Dispersion 1)

C.I. Pigment Red 57:1: 15 parts by weight
Polymeric dispersing agent (one out of SOLSPERS series, manufactured by Zeneca Co.): 5 parts by weight
Oxetane compound (trade name: OXT-221, manufactured by Toagosei Co., Ltd.): 80 parts by weight

(Cyano Pigment Dispersion 1)

C.I. Pigment Blue 15:3: 20 parts by weight
Polymeric dispersing agent (one out of SOLSPERS series, manufactured by Zeneca Co.): 5 parts by weight
Oxetane compound (trade name: OXT-221, manufactured by Toagosei Co., Ltd.): 75 parts by weight

(Black Pigment Dispersion 1)

C.I. Pigment Black 7: 20 parts by weight
Polymeric dispersing agent (one out of SOLSPERS series, manufactured by Zeneca Co.): 5 parts by weight
Oxetane compound (trade name: OXT-221, manufactured by Toagosei Co., Ltd.): 75 parts by weight

### EXAMPLE A1

### Preparation of Ink

Components described below were mixed with each other, and the mixture was filtrated with a filter to prepare each color ink.

### (Yellow Ink 1)

### (a) Condensed Cyclic Lactone Compound:

### A-1: 30 g

### (b) Photo-Acid Generator:

Agent (trade name: UVI-6992, manufactured by Dow Chemical Co.): 5 g

### (c) Cationically Polymerizable Compounds:

Epoxy compound (trade name: CELOXIDE [transliteration] 2021, manufactured by Daicel UCB Kabushiki Kaisha [transliteration]): 35 g

Oxetane compound (trade name: OXT-221, manufactured by Toagosei Co., Ltd.): 25 g

### (d) Colorant (One of the Above-Mentioned Pigment Dispersions):

Yellow pigment dispersion 1: 5 g

### Additive:

Sensitizer: 9,10-Dimethoxyanthracene: 0.5 g

(Magenta Ink 1)

### (a) Condensed Cyclic Lactone Compound:

### A-1: 30 g

### (b) Photo-Acid Generator:

Agent (trade name: UVI-6992, manufactured by Dow Chemical Co.): 5 g

### (c) Cationically Polymerizable Compounds:

Epoxy compound (trade name: CELOXIDE [transliteration] 2021, manufactured by Daicel UCB Kabushiki Kaisha [transliteration]): 35 g

Oxetane compound (trade name: OXT-221, manufactured by Toagosei Co., Ltd.): 25 g

### (d) Colorant (One of the Above-Mentioned Pigment Dispersions):

Magenta pigment dispersion 1: 5 g

(Cyan Ink 1)

### (a) Condensed Cyclic Lactone Compound:

### A-1: 30 g

### (b) Photo-Acid Generator:

Agent (trade name: UVI-6992, manufactured by Dow Chemical Co.): 5 g

### (c) Cationically Polymerizable Compounds:

Epoxy compound (trade name: CELOXIDE [transliteration] 2021, manufactured by Daicel UCB Kabushiki Kaisha [transliteration]): 35 g

Oxetane compound (trade name: OXT-221, manufactured by Toagosei Co., Ltd.): 25 g

### (d) Colorant (One of the Above-Mentioned Pigment Dispersions):

Cyan pigment dispersion 1: 5 g

### Additive:

Sensitizer: 9,10-Dimethoxyanthracene: 0.5 g

(Black Ink 1)

### (a) Condensed Cyclic Lactone Compound:

### A-1: 30 g

### (b) Photo-Acid Generator:

Agent (trade name: UVI-6992, manufactured by Dow Chemical Co.): 5 g

### (c) Cationically Polymerizable Compounds:

Epoxy compound (trade name: CELOXIDE [transliteration] 2021, manufactured by Daicel UCB Kabushiki Kaisha [transliteration]): 35 g

Oxetane compound (trade name: OXT-221, manufactured by Toagosei Co., Ltd.): 25 g

### (d) Colorant (One of the Above-Mentioned Pigment Dispersions):

Black pigment dispersion 1: 5 g

### Additive:

Sensitizer: 9,10-Dimethoxyanthracene: 0.5 g

### <<Inkjet Image Recording>>

### (Evaluation of Multicolor Image)

An image was recorded on a recording medium by using a commercially available inkjet recording apparatus equipped with a piezoelectric inkjet nozzle. The ink-supplying system is composed of an ink stock tank, a supply pipe, an ink-supplying tank positioned immediately anterior to an inkjet head, a filter, and a piezoelectric inkjet head. The region ranging from the ink-supplying tank to the inkjet head was insulated and heated. The temperature sensors were placed close to the ink-supplying tank and inkjet head nozzle, and the nozzle part is controlled so that the temperature is constantly in the range of 70° C.±2° C. The piezoelectric inkjet head was driven to eject multi-sized dots of from 8 to 30 pl at a resolution of 720×720 dpi. The exposure system, main scanning speed, and injection frequency were adjusted in such a manner that irradiation of a UV-A beam started 0.1 second after ejection of the ink onto the recording medium, in an focused manner with an exposed-face illuminance of 100 mW/cm2. Exposure energy was irradiated at variable exposure time periods. The term “dpi” in the present invention means a number of dots per 2.54 cm.

The inks of respective colors were ejected at an environment temperature of 25° C. in order of black, cyan, magenta, and yellow. Each ink was irradiated with an ultraviolet beam after ejection, respectively. The irradiation was performed so that the total exposure energy for each color is equally 300 mJ/cm2, under which the ink cured completely and the tackiness thereof was not felt by the finger. The image was recorded on recording mediums of a surface-roughened aluminum substrate, a transparent biaxially-stretched polypropylene film with the surface treated to be suitable for printing, a soft vinyl chloride sheet, a cast-coated paper, and a commercially available recycled paper. An image with a high resolution and no dot blurring was obtained in all cases of the recording medium. Even in the case of a bond paper, the ink was cured sufficiently and there was no penetration of the ink to the back face of the paper or generation of odor derived from unreacted monomer. In addition, the ink recorded on the film had sufficient flexibility and there was no crack when the film was bent, as well as that there was no problem in adhesiveness in a cellophane-tape peeling test.

### EXAMPLES B1 TO B10, AND COMPARATIVE EXAMPLES B1 AND B2

### Preparation of Inks

Components described below were mixed with each other, and the mixture was filtrated with a filter to prepare each of ink compositions of Examples B1 to B10 (each of ink B1 to B10). An ink composition of Comparative Example 1 (ink B11) was yielded in the same way as in Example 10 except that out of all the components of the ink composition of Example 10, the condensed cyclic lactone compound (c) was not used. An ink composition of Comparative Example 1 (ink B12) was yielded in the same way as in Example 10 except that the condensed cyclic lactone compound (c) was changed to γ-butyrolactone in the ink composition of Example 10.

(Each of Inks B1 to B12)

(a) Condensed cyclic lactone compound (shown in Table 1): 45 g
(b) Photo-acid generator(s) (shown in Table 1): 5 g
(c) Cationically polymerizable compound (shown in Table 1): 45 g
(d) Colorant (shown in Table 1): 5 g
Sensitizer (9,10-dimethoxyanthracene): 0.5 g

The blend ratio between the two exemplified compounds used in the photo-acid generators (b) described in each of the columns “Example B1” to “Example B5” in Table 1 is as follows:

Ratio by weight of the generator b-24 to the generator b-29=1/1

Details of the cationically polymerizable compounds (b) shown in Table 1 are as follows:

### Cationically Polymerizable Compound (1):

Product wherein an epoxy compound (trade name: CELOXIDE

[transliteration] 2021, manufactured by Daicel UCB Kabushiki Kaisha

[transliteration]) and an oxetane compound (trade name: OXT-101, manufactured by Toagosei Co., Ltd.) were mixed with each other at a ratio by weight of 55/35.

### Cationically Polymerizable Compound (2):

Product wherein an epoxy compound (trade name: CELOXIDE

[transliteration] 2021, manufactured by Daicel UCB Kabushiki Kaisha

[transliteration]) and an oxetane compound (trade name: OXT-101, manufactured by Toagosei Co., Ltd.) were mixed with each other at a ratio by weight of 65/25.

Colorants Y, M, C, and K shown in Table 1 represent the above-mentioned yellow pigment dispersion 1, magenta pigment dispersion 1, cyan pigment dispersion 1, and black pigment dispersion 1, respectively.

Colorant W used in Example B 5 was a white pigment dispersion having a composition described below, and was prepared in the same way as the yellow pigment dispersion 1 except that a different composition was used.

(White Pigment Dispersion 1)

Titanium oxide (average particle diameter: 0.15 μm, and refractive index: 2.52): 25 parts by weight

Polymeric dispersing agent (one out of SOLSPERS series, manufactured by Zeneca Co.): 5 parts by weight

Diethylene glycol divinyl ether (manufactured by BASF): 60 parts by weight

The ink viscosity of each ink composition obtained in Example B and Comparative Example B about at the ejection temperature was in a range of 7 to 20 mP·s.

[Inkjet Image Recording] (Evaluation of Monochromatic Images)

A monochromatic image in each color was recorded in the same way as in Example A1 except that each of the ink compositions of Examples B1 to B10 and Comparative Examples B1 and B2 (i.e., inks B1 to B12) only was used in the inkjet recording method described in Example A1.

[Evaluation of Inkjet Images]

Next, each of the ink compositions of the series of Examples B and the series of Comparative Examples B (inks B1 to B12) was evaluated about the sensitivity necessary for curing, the storage stability, the penetrating power in commercially available recycled paper, ink bleeding on a surface-roughness aluminum substrate, and the adhesiveness onto a surface-roughness aluminum substrate in accordance with methods described below.

### 1. Evaluation of Curing Sensitivity

The amount of exposure energy (mJ/cm2) at which the surface of the image loses tackiness after UV irradiation was defined as curing sensitivity. A smaller value indicates a higher sensitivity.

### 2. Evaluation of Storage Stability

After the inks prepared were stored at 75% RH and 60° C. for three days, ink viscosity was determined at the ejection temperature, and increase in the ink viscosity was determined as viscosity ratio, i.e., viscosity after storage/viscosity before storage. The viscosity ratio being closer to 1.0 indicates a smaller change in viscosity and better storage stability, and the ink with the viscosity ratio exceeding 1.5 is not favorable since nozzle clogging may occur at the time of ejection.

3. Evaluation of Penetrability into Commercially Available Recycled Paper

Images printed on a commercially available recycled paper were evaluated according to the following criteria:

A: Almost no penetration and no residual monomer odor

B: Penetration and residual monomer odor were slightly observed

C: Distinct penetration of ink to the back face side and strong residual monomer odor were observed

### 4. Evaluation of Ink Bleeding on Surface-Roughened Aluminum Recording Medium

Images printed on a surface-roughened aluminum substrate were evaluated according to the following criteria:

A: No ink bleeding was observed in between the adjacent dots

B: Ink bleeding of dots was slightly observed

C: Distinct ink bleeding of dots and blurring of image were observed

### 5. Evaluation of Adhesiveness to Surface-Roughened Aluminum Recording Medium

Two samples were prepared by printing an image of a surface roughened aluminum substrate, wherein one sample had no cut on the image, while the other sample had 11 cuts each in longitudinal and lateral directions at an interval of 1 mm to form 100 squares of 1 mm×1 mm, according to JIS K 5400. A cellophane tape was attached on the image and peeled rapidly at an angle of 90 degrees. The images or the squares that remained unpeeled were evaluated according to the following criteria:

A: No peeling of the image was observed even in the cross-cut image

B: Peeling of ink was slightly observed in the cross-cut image, but no peeling was observed in the image without cuts

C: Easy peeling of the image was observed in both samples

(Evaluation of Planographic Printing Plate)

An image was formed on the surface-roughened aluminum recording medium prepared in accordance with the above-mentioned method, using the ink composition of the present invention. The recording medium was evaluated as a planographic printing plate.

a. Evaluation of Image

Printing was performed by placing the planographic printing plate prepared using the ink composition of the present invention into a Heidel KOR-D printing machine, and supplying an ink [VALUES-G Red, for sheet-fed printing (manufactured by Dainippon Ink and Chemicals, Inc.)] and a dampening water [Ecolity 2 (manufactured by Fuji Film Corporation)]. The image after printing 100 sheets was visually evaluated according to the following criteria.

A: No whitening in the image region or no staining in non-image region was observed.

B: Whitening in image region and/or staining in non-image region were slightly observed.

C: Whitening in image region and/or staining in non-image region were observed, which were problematic in practical use.

b. Evaluation of Printing Durability

Printing was continued, and the number of sheets which could be printed was determined as the indicator of printing durability. The number of sheets was relatively compared, where the result in Comparative Example 1 was determined as 100. A greater value indicates a better printing durability.

The evaluation results are summarized in Table 1.

TABLE 1

| | Ex- | Ex- | Ex- | Ex- | Ex- | Ex- | Ex- | Ex- | Ex- | Ex- | | |
|---|---|---|---|---|---|---|---|---|---|---|---|---|
| | ample | ample | ample | ample | ample | ample | ample | ample | ample | ample | Comparative | Comparative |
| | B1 | B2 | B3 | B4 | B5 | B6 | B7 | B8 | B9 | B10 | Example B1 | Example B2 |
| Condensed | A-1 | A-1 | A-1 | A-1 | A-1 | A-3 | A-4 | A-5 | A-6 | A-7 | Not | γ-butyro- |
| cyclic lactone | | | | | | | | | | | contained | lactone |
| compound (a) | | | | | | | | | | | | |
| Photo-acid | b-24/ | b-24/ | b-24/ | b-24/ | b-24/ | b-3 | b-3 | b-3 | b-3 | b-3 | b-3 | b-3 |
| generator (b) | b-29 | b-29 | b-29 | b-29 | b-29 | | | | | | | |
| Cationically | 1 | 1 | 1 | 1 | 1 | 2 | 2 | 2 | 2 | 2 | 1 | 1 |
| polymerizable | | | | | | | | | | | | |
| compound (c). | | | | | | | | | | | | |
| Colorant (d) | Y | C | M | K | W | M | M | M | M | M | M | M |
| Curing | 220 | 240 | 220 | 230 | 240 | 250 | 250 | 260 | 250 | 240 | 300 | 360 |
| sensitivity | | | | | | | | | | | | |
| (mJ/cm²) | | | | | | | | | | | | |
| Adhesiveness | 1 | 1 | 1 | 1 | 1 | 1 | 1 | 1 | 1 | 1 | 3 | 2 |
| (cross hatch | | | | | | | | | | | | |
| test) | | | | | | | | | | | | |
| Bending test | A | A | A | A | A | A | A | A | A | A | B | A |
| Penetrating | A | A | A | A | A | A | A | A | A | A | A | A |
| power into | | | | | | | | | | | | |
| recycled paper | | | | | | | | | | | | |
| Bleeding on | A | A | A | A | A | A | A | A | A | A | A | B |
| aluminum | | | | | | | | | | | | |
| substrate | | | | | | | | | | | | |
| Adhesiveness | A | A | A | A | A | A | A | A | A | A | A | A |
| on aluminum | | | | | | | | | | | | |
| substrate | | | | | | | | | | | | |
| Ink storage | 1.1 | 1.1 | 1.2 | 1.2 | 1.2 | 1.1 | 1.1 | 1.2 | 1.1 | 1.1 | 1.1 | 1.1 |
| stability | | | | | | | | | | | | |
| Evaluation of | A | A | A | A | A | A | A | A | A | A | A | A |
| image on | | | | | | | | | | | | |
| planographic | | | | | | | | | | | | |
| printing plate | | | | | | | | | | | | |
| Printing | 140 | 120 | 110 | 130 | 130 | 130 | 100 | 110 | 130 | 120 | 100 | 80 |
| durability | | | | | | | | | | | | |

According to the results in Table 1, the ink composition of each of Examples was irradiated with the radiation ray so as to be cured with a high sensitivity. About the image formability on the paper, a result that a high-quality image was able to be formed was obtained. The storage stability was also good. In such a manner, in the invention, an ink is produced which has a high curing sensitivity, is restrained from bleeding on a non-penetrable substrate, and is excellent in adhesiveness and film strength.

On the other hand, the ink composition of Comparative Example 1, which did not contain any condensed cyclic lactone compound (a), problems were caused about the curing sensitivity and the film strength in the bending test. The ink composition of Comparative Example 2, which contained the non-condensed cyclic lactone (γ-butyrolactone) instead of the condensed cyclic lactone compound (a), was low in curing sensitivity, and the performance about bleeding on the aluminum substrate was somewhat poor.

It was also understood that in the planographic printing plate wherein an image is formed by use of the ink composition of the invention, a high-quality can be formed, and further the printing curability is also good.

The ink composition of the present invention, when used in ordinary printing process, forms an image that is high quality and strength to provide a high quality printed material. The ink composition is also favorably used in production of resists, color filters, and optical disks, and is further useful as an optical modeling material.

Furthermore, the ink composition of the present invention cures with high sensitivity even on a non-absorptive recording medium, and is capable of directly forming an image region being high in strength, based on digital data. Accordingly, the ink composition of the present invention can be favorably used for preparation of a planographic printing plate, in particular a planographic printing plate having a size of A2 or larger, and provides a planographic printing plate superior in printing durability.

The invention also includes the following embodiments.

<1> An ink composition comprising: a condensed cyclic lactone compound; a compound that generates an acid when irradiated with a radiation ray; a cationically polymerizable compound; and a colorant.

<2> The ink composition of item <1>, wherein the condensed cyclic lactone compound is a compound having at least one selected from the group consisting of structures represented by the following formulae (I-a) to (I-f):

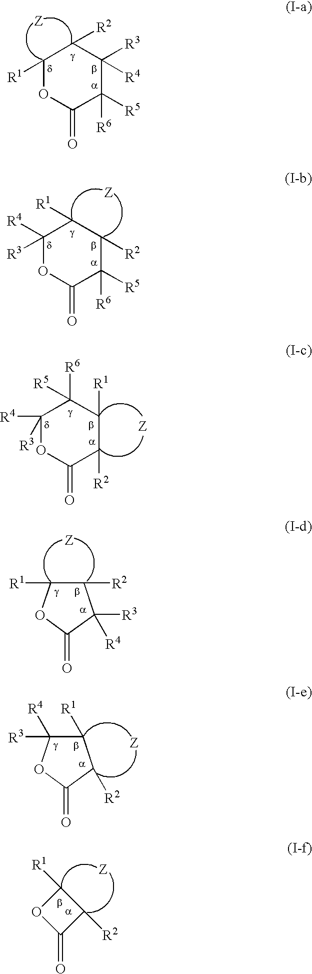

wherein Z in formulae (I-a) to (I-f) represents a group which is combined with two carbon atoms which are constituents of a lactone ring, are adjacent to each other in the lactone ring and are bonded to Z, to form at least one condensed ring selected from the group constituting of 5-membered and 6-membered rings,

R¹ and R² in formulae (I-a) to (I-f) each represent a hydrogen atom when (A) one of the carbon atoms which are constituents of the lactone ring and an atom which is directly bonded to this carbon atom and is a constituents of Z, form a single bond, and R¹ and R² are not present when (B) one of the carbon atoms which are constituents of the lactone ring and the atom which is directly bonded to this carbon atom and is a constituents of Z form a double bond,

R³ and R⁴ in formulae (I-a) to (I-e) each represent a hydrogen atom or a hydrocarbon group having 1 to 20 carbon atoms when (C) R³ and R⁴ are not bonded to each other (provided that when one of the carbon atoms which are constituents of the lactone ring and an atom of R³ (or R⁴) which is directly bonded to this carbon atom form a double bond, R⁴ (or R³) is not present), and R³ and R⁴ are constituents of a part of a group having a cyclic structure composed of R³, R⁴, and carbon atoms which are bonded to both of R³ and R⁴ and are constituents of the lactone ring, wherein the group having the cyclic structure represents a cyclic hydrocarbon group having 3 to 20 carbon atoms in which a cyclic structure composed of R³, R⁴, and the carbon atoms which are bonded to both of R³ and R⁴ and constitute the lactone ring forms a 3-membered to 8-membered ring when (D) R³ and R⁴ are bonded to each other, and

R⁵ and R⁶ in the formulae (I-a) to (I-c) each represent a hydrogen, or a hydrocarbon group having 1 to 20 carbon atoms when (E) R⁵ and R⁶ are not bonded to each other (provided that when one of the carbon atoms which are constituents of the lactone ring and an atom of R⁵ (or R⁶) which is directly bonded to this carbon atom form a double bond, R⁶ (or R⁵) is not present), and R⁵ and R⁶ are constituents of a part of a group having a cyclic structure composed of R⁵, R⁶, and carbon atoms which are bonded to both of R⁵ and R⁶ and are constituents of the lactone ring, wherein the group having the cyclic structure represents a cyclic hydrocarbon group having 3 to 20 carbon atoms in which a cyclic structure composed of R⁵, R⁶, and the carbon atoms which are bonded to both of R⁵ and R⁶ and are constituents of the lactone ring forms a 3-membered to 8-membered ring when (F) R⁵ and R⁶ are bonded to each other.

<3> The ink composition of any one of items <1> and <2>, wherein an epoxy compound is used as the cationically polymerizable compound.

<4> The ink composition of any one of items <1> to <3>, wherein the condensed cyclic lactone compound and the epoxy compound are contained in a ratio by mass of 1:2 to 2:1.

<5> The ink composition of any one of items <1> to <3>, <5>, wherein the condensed cyclic lactone compound is contained in an amount of 10 to 80 parts by mass with respect to a total of 100 parts by mass of the total of the ink composition.

<6> An inkjet recording method, comprising ejecting the ink composition of any one of items <1> to <3>, <5>, and <8> onto a recording medium through an inkjet printer, and irradiating the ejected ink composition with a radiation ray, thereby curing the composition. 13.

<7> A printed material, obtained by ejecting the ink composition of item <1> onto a recording medium through an inkjet printer, and irradiating the ink composition with a radiation ray, thereby curing the ink composition.

<8> A method of producing a planographic printing plate, comprising ejecting the ink composition of item <1> onto a hydrophilic substrate, and irradiating the ink composition with a radiation ray to cure the ink composition, thereby forming a hydrophobic region.

<9> A planographic printing plate having a hydrophobic region formed by ejecting the ink composition of item <1> onto a hydrophilic substrate, and irradiating the ink composition with a radiation ray, thereby curing the composition.

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

What is claimed is:

1. An ink composition comprising:
a condensed cyclic lactone compound;
a compound that generates an acid when irradiated with a radiation ray;
a cationically polymerizable compound; and
a colorant.

2. The ink composition of claim 1, wherein the condensed cyclic lactone compound is a compound having at least one selected from the group consisting of structures represented by the following formulae (I-a) to (I-f): 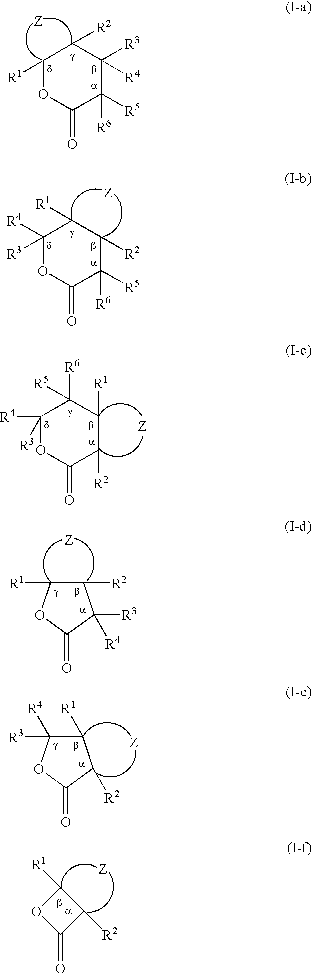
wherein Z in formulae (I-a) to (I-f) represents a group which is combined with two carbon atoms which are constituents of a lactone ring, are adjacent to each other in the lactone ring and are bonded to Z, to form at least one condensed ring selected from the group constituting of 5-membered and 6-membered rings,
R¹ and R² in formulae (I-a) to (I-f) each represent a hydrogen atom when (A) one of the carbon atoms which are constituents of the lactone ring and an atom which is directly bonded to this carbon atom and is a constituents of Z, form a single bond, and R¹ and R² are not present when (B) one of the carbon atoms which are constituents of the lactone ring and the atom which is directly bonded to this carbon atom and is a constituents of Z form a double bond,
R³ and R⁴ in formulae (I-a) to (I-e) each represent a hydrogen atom or a hydrocarbon group having 1 to 20 carbon atoms when (C) R³ and R⁴ are not bonded to each other (provided that when one of the carbon atoms which are constituents of the lactone ring and an atom of R³ (or R⁴) which is directly bonded to this carbon atom form a double bond, R⁴ (or R³) is not present), and R³ and R⁴ are constituents of a part of a group having a cyclic structure composed of R³, R⁴, and carbon atoms which are bonded to both of R³ and R⁴ and are constituents of the lactone ring, wherein the group having the cyclic structure represents a cyclic hydrocarbon group having 3 to 20 carbon atoms in which a cyclic structure composed of R³, R⁴, and the carbon atoms which are bonded to both of R³ and R⁴ and constitute the lactone ring forms a 3-membered to 8-membered ring when (D) R³ and R⁴ are bonded to each other, and
R⁵ and R⁶ in the formulae (I-a) to (I-c) each represent a hydrogen, or a hydrocarbon group having 1 to 20 carbon atoms when (E) R⁵ and R⁶ are not bonded to each other (provided that when one of the carbon atoms which are constituents of the lactone ring and an atom of R⁵ (or R⁶) which is directly bonded to this carbon atom form a double bond, R⁶ (or R⁵) is not present), and R⁵ and R⁶ are constituents of a part of a group having a cyclic structure composed of R⁵, R⁶, and carbon atoms which are bonded to both of R⁵ and R⁶ and are constituents of the lactone ring, wherein the group having the cyclic structure represents a cyclic hydrocarbon group having 3 to 20 carbon atoms in which a cyclic structure composed of R⁵, R⁶, and the carbon atoms which are bonded to both of R⁵ and R⁶ and are constituents of the lactone ring forms a 3-membered to 8-membered ring when (F) R⁵ and R⁶ are bonded to each other.

3. The ink composition of claim 1, wherein an epoxy compound is used as the cationically polymerizable compound.

4. The ink composition of claim 2, wherein an epoxy compound is used as the cationically polymerizable compound.

5. The ink composition of claim 1, wherein the condensed cyclic lactone compound and the epoxy compound are contained in a ratio by mass of 1:2 to 2:1.

6. The ink composition of claim 2, wherein the condensed cyclic lactone compound and the epoxy compound are contained in a ratio by mass of 1:2 to 2:1.

7. The ink composition of claim 3, wherein the condensed cyclic lactone compound and the epoxy compound are contained in a ratio by mass of 1:2 to 2:1.

8. The ink composition of claim 1, wherein the condensed cyclic lactone compound is contained in an amount of 10 to 80 parts by mass with respect to a total of 100 parts by mass of the total of the ink composition.

9. The ink composition of claim 2, wherein the condensed cyclic lactone compound is contained in an amount of 10 to 80 parts by mass with respect to a total of 100 parts by mass of the total of the ink composition.

10. The ink composition of claim 3, wherein the condensed cyclic lactone compound is contained in an amount of 10 to 80 parts by mass with respect to a total of 100 parts by mass of the total of the ink composition.

11. The ink composition of claim 5, wherein the condensed cyclic lactone compound is contained in an amount of 10 to 80 parts by mass with respect to a total of 100 parts by mass of the total of the ink composition.

12. An inkjet recording method, comprising ejecting the ink composition of claim 1 onto a recording medium through an inkjet printer, and irradiating the ejected ink composition with a radiation ray, thereby curing the composition.

13. An inkjet recording method, comprising ejecting the ink composition of claim 2 onto a recording medium through an inkjet printer, and irradiating the ejected ink composition with a radiation ray, thereby curing the composition.

14. An inkjet recording method, comprising ejecting the ink composition of claim 3 onto a recording medium through an inkjet printer, and irradiating the ejected ink composition with a radiation ray, thereby curing the composition.

15. An inkjet recording method, comprising ejecting the ink composition of claim 5 onto a recording medium through an inkjet printer, and irradiating the ejected ink composition with a radiation ray, thereby curing the composition.

16. An inkjet recording method, comprising ejecting the ink composition of claim 8 onto a recording medium through an inkjet printer, and irradiating the ejected ink composition with a radiation ray, thereby curing the composition.

17. A printed material, obtained by ejecting the ink composition of claim 1 onto a recording medium through an inkjet printer, and irradiating the ink composition with a radiation ray, thereby curing the ink composition.

18. A method of producing a planographic printing plate, comprising ejecting the ink composition of claim 1 onto a hydrophilic substrate, and irradiating the ink composition with a radiation ray to cure the ink composition, thereby forming a hydrophobic region.

19. A planographic printing plate having a hydrophobic region formed by ejecting the ink composition of claim 1 onto a hydrophilic substrate, and irradiating the ink composition with a radiation ray, thereby curing the composition.
